(19) United States
(12) Patent Application Publication
(10) Pub. No.: US 2016/0028828 A1
(43) Pub. Date: Jan. 28, 2016

(54) HUB AND CLOUD BASED CONTROL AND AUTOMATION

(71) Applicant: OORT EUROPE S.A., Wroclaw (PL)

(72) Inventors: Radoslaw Tadajewski, Wroclaw (PL); Krzysztof Maziarz, Wroclaw (PL); Adam Handzlik, Wroclaw (PL)

(21) Appl. No.: 14/807,698

(22) Filed: Jul. 23, 2015

Related U.S. Application Data
(60) Provisional application No. 62/028,992, filed on Jul. 25, 2014.

(51) Int. Cl. H04L 29/08; H04W 4/06; H04W 4/00

(52) U.S. Cl. CPC H04L 67/125; H04W 4/008; H04W 4/06; H04W 84/18

(57) ABSTRACT

Systems and methods for controlling physical objects are provided herein. A system comprises a plurality of beacons that each comprise a Bluetooth low energy interface and an interface for communicatively coupling with an electronic device or mechanical device; a hub that communicates with and controls the plurality of beacons, the hub also comprising a Bluetooth low energy interface and a network interface for coupling with a cloud, the hub collecting data from the plurality of beacons; the cloud being configured to: process and store the data collected from the plurality of beacons; and generate reports from the data; and the hub being controlled by an end user computing device when the end user computing device is within a broadcast area of the hub, the end user computing device controlling the hub through the cloud when the end user computing device is not within the broadcast area of the hub.

### CROSS-REFERENCE TO RELATED APPLICATIONS

This U.S. Nonprovisional patent application claims the benefit and priority of U.S. Provisional Patent Application Ser. No. 62/028,992 filed on Jul. 25, 2014, titled “Hub and Cloud Based Control and Automation,” which is hereby incorporated by reference.

### FIELD OF THE INVENTION

The present invention relates to remote automation and security, and more specifically, but not by limitation to a hub and cloud combination that cooperate with remote sensors and actuators to control and/or automate many types of physical objects.

### BACKGROUND OF THE INVENTION

Many people are dependent upon smartphones, tablets and appliances every day for business and pleasure. For instance, people use smartphones and tablets to message and text each other. They also use these devices for word processing and email applications. Some people also use appliances such as toasters, toaster ovens and stoves, to cook meals in their homes. Others use appliances like the refrigerator to store food.

### SUMMARY OF THE INVENTION

An object of the present invention is to provide systems and methods for remote control and automation of many types of physical objects.

Yet another object of the present invention is to provide a mechanism for storing and collecting data using a hub and cloud combination.

A further object of the present invention is to track and locate any physical object or person using the hub and cloud combination as described herein.

### BRIEF DESCRIPTION OF THE DRAWINGS

FIGS. 1-4 are illustrations of various embodiments of the present invention.

FIG. 5 is a block diagram of an exemplary architecture of a system in accordance with various embodiments of the present invention.

FIG. 6 is a block diagram of an exemplary hub in accordance with various embodiments of the present invention.

FIG. 7 is an illustration of exemplary beacons as used in certain embodiments of the present invention.

FIG. 8 is a block diagram of an exemplary sensor in accordance with various embodiments of the present invention.

FIGS. 9, 10A-10G are illustrations of smartphones and graphic user interfaces presented on smartphones in accordance with various embodiments of the present invention.

FIGS. 11-15 are illustrations of certain use cases of the present invention.

FIGS. 16-44 depict examples of various embodiments in accordance with various embodiments of the present invention.

FIG. 45 is an example computing device that can be used to practice aspects of the present technology.

FIG. 46 is an exemplary button actuator that can be used to practice aspects of the present technology.

FIGS. 47 and 48 are further depictions of various use cases of the present invention.

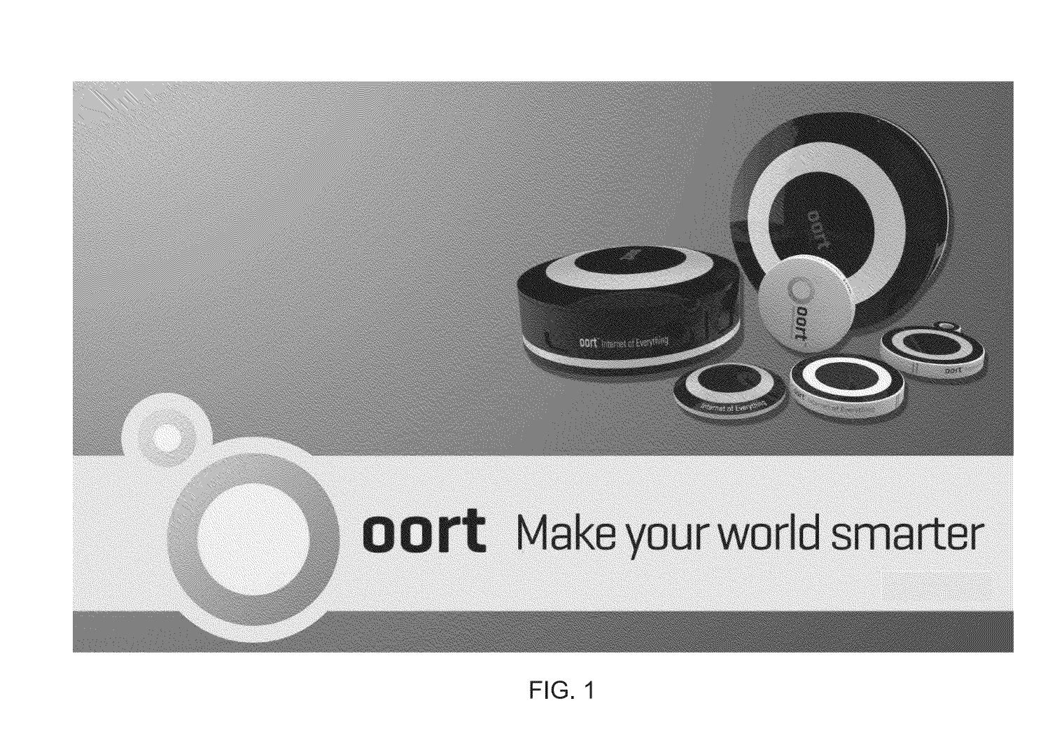

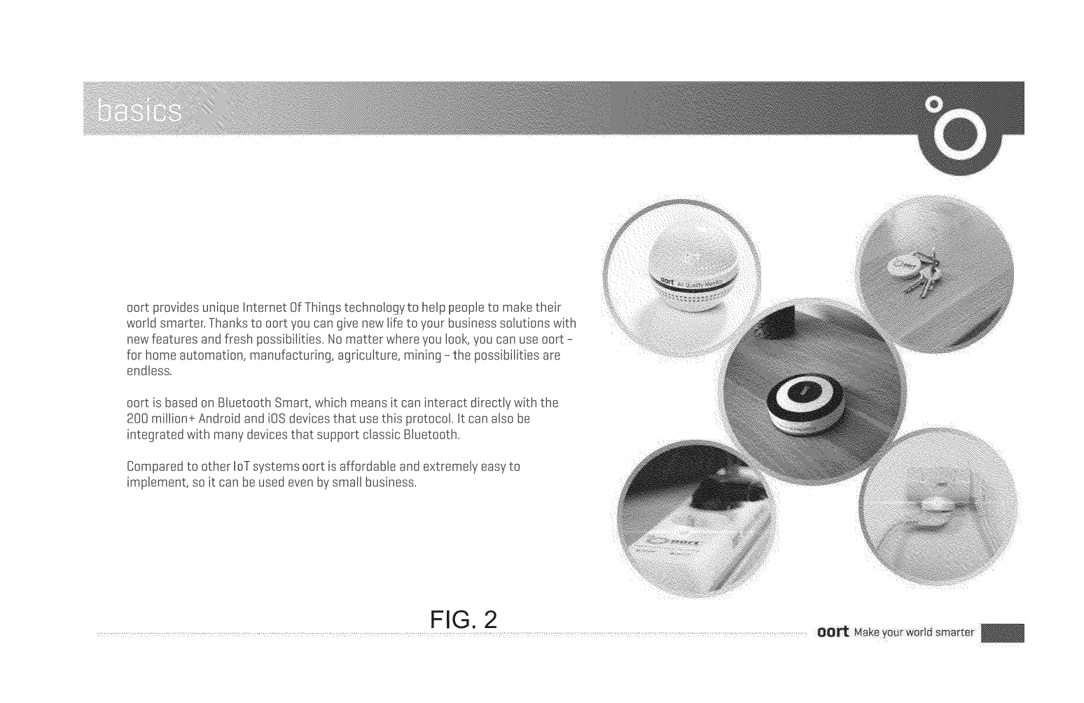

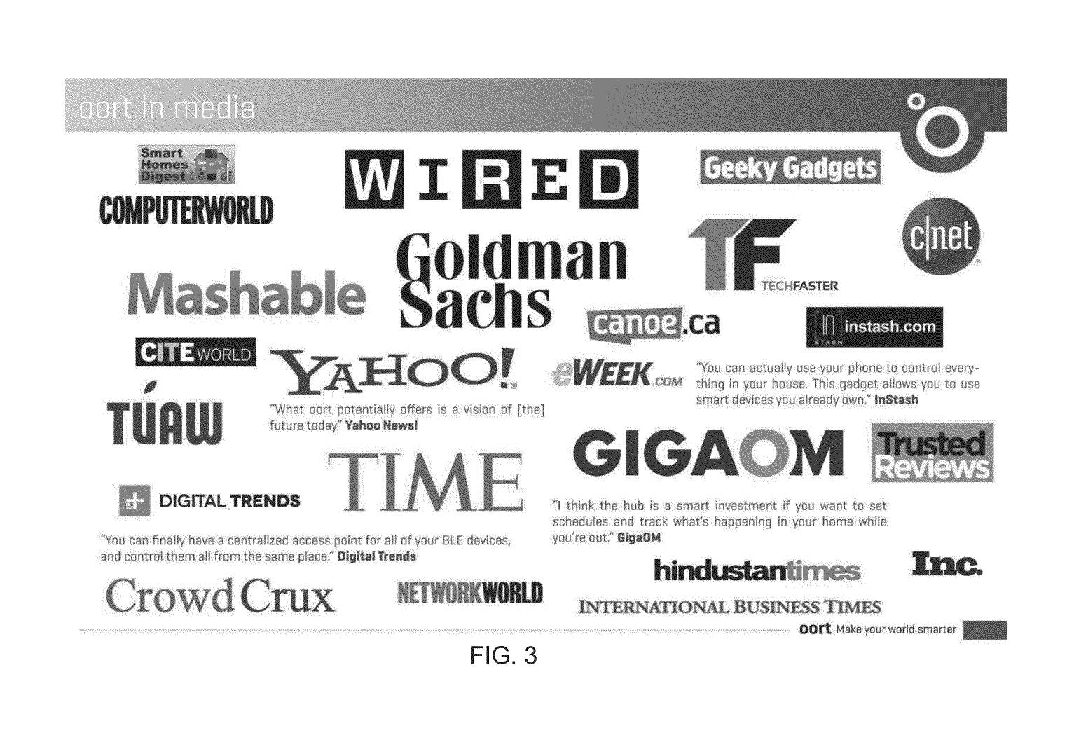

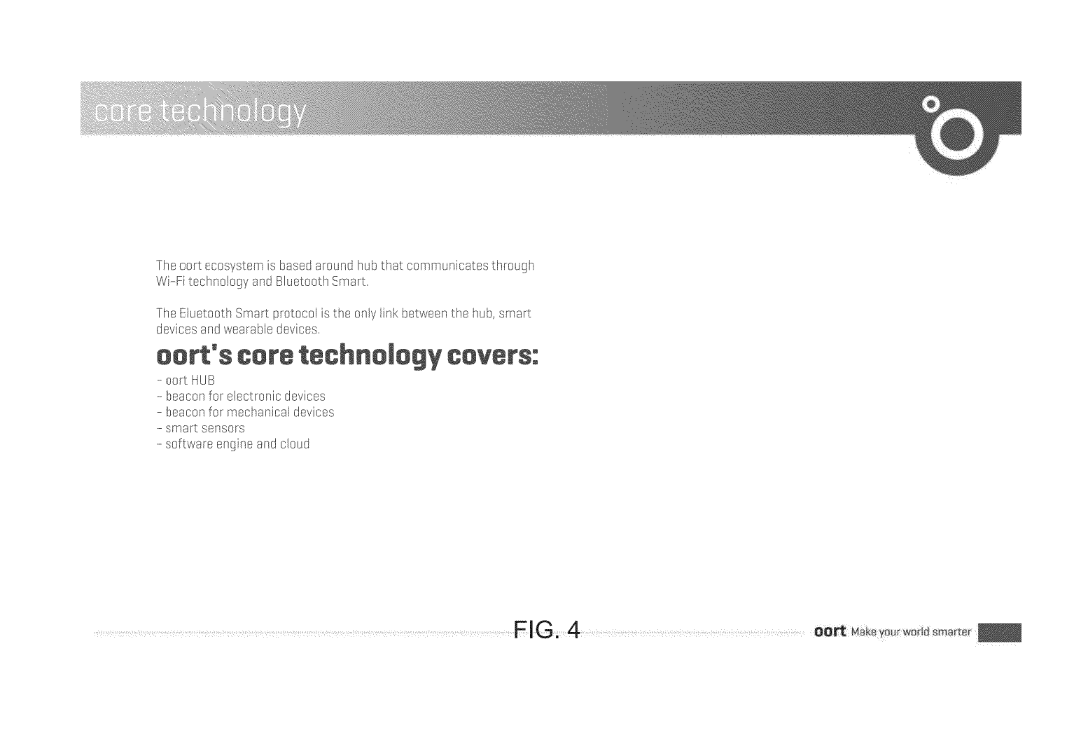

### DETAILED DESCRIPTION OF THE INVENTION

Generally described, the present technology provides an ecosystem of smart devices, which makes use of Bluetooth SMART protocols. The present technology leverages a smart HUB. Some embodiments may reference the use of a smart sensor. A smart sensor can be generally described as comprising at least a sensor (or sensors) that senses some type of activity, action, state, use, or other similar operational characteristic. The term “smart sensor” as used herein can be a Bluetooth controller which allows one to control different physical objects or devices. Also the smart sensors comprises a beacon that allows the sensor to communicatively couple with the smart HUB, as well as a control device that allows actuation of a device to which the smart sensor is coupled. For example, a smart sensor comprising a power adapter is coupled to a television. The smart sensor comprises a control module that includes or actuates a switch that turns power for the television on and off.

In some embodiments, beacons such as wearable devices can interact with the HUB and smart devices. For example, a Smartband such as a Smartwatch or wristband that can be used to control device or process (application specific accelerometer algorithm).

The method of communication between the hub and smart devices assures efficient device discovery, identification, and configuration. The present technology also provides a unique method of data transfer between smart devices and cloud server aimed at limiting data streams and data storage for data that is produced by the smart devices and the hub.

The present technology also implements a dual level control strategy, where the goal of the solution is to assure execution of local control of smart home in case Internet connection is lost. The present technology also provides power consumption reduction by use of special algorithm changing advertising (smart device reporting) periods depending on data structure. In some embodiments, use of alternative power sources for supplying power to beacons such as pressure, radio frequency harvesting, temperature, motion, and magnetic field sources, is contemplated.

Some embodiments provide new control devices allowing far more precise control by use of differential accelerometers that allow for the ability to distinguish between linear and circular movement of a hand.

Also, in-door navigation (in-door GPS) can be accomplished using UWB (ultra wide band) anchors and tags, as well as dual wide band (Ultra wide band+Bluetooth smart).

In an example use case, the present technology can be used to create virtual 3D routes for any movable objects (e.g., quadrocopters, cars, or shopping carts). The present technology also provides for personal tracking/microfencing system for schools with real time monitoring system.

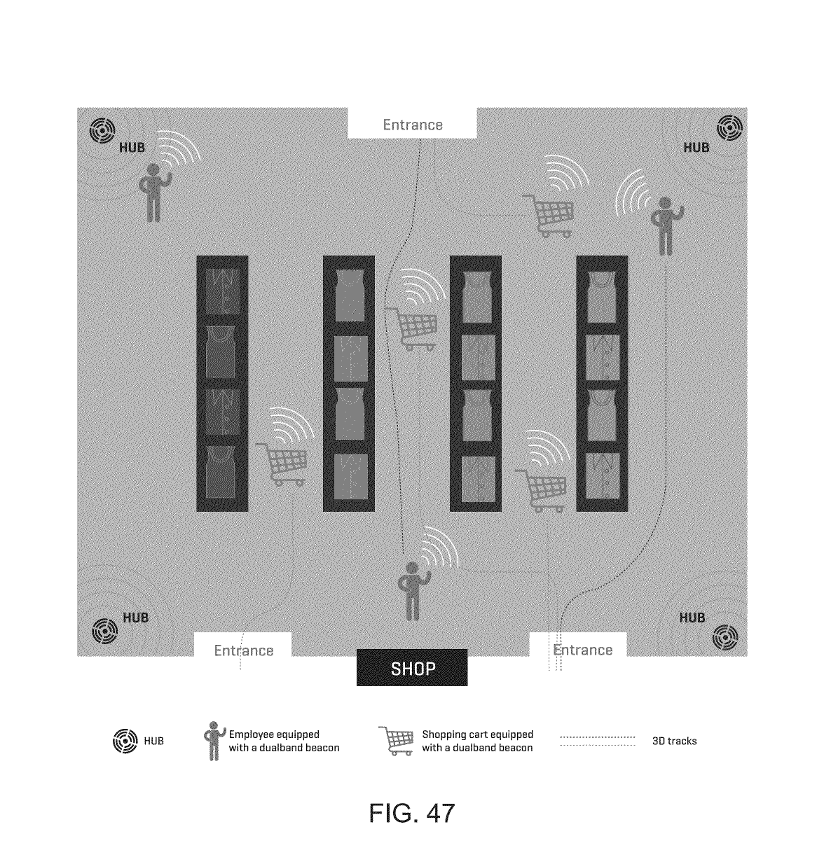

Another example use case using dual wide band (Ultra wide band+Bluetooth smart) beacons is shown in FIG. 47. FIG. 47 depicts a store with four hubs installed. Each hub uses Bluetooth, Wi-Fi, Ultra Wide Band or GSM network. The four hubs in the store work as radio lanterns which can be used to triangulate and track any person or object using dual band beacon. These hubs are smarthubs which may have a range of coverage of at least 100 meters range and which can be used to track physical objects or people with great accuracy. Using the hubs, the store management can track and police shopping carts, as well as people flow. Based on this information, store management can also know where and when to replace product throughout the store. The beacons can be positioned in two or three dimensional space.

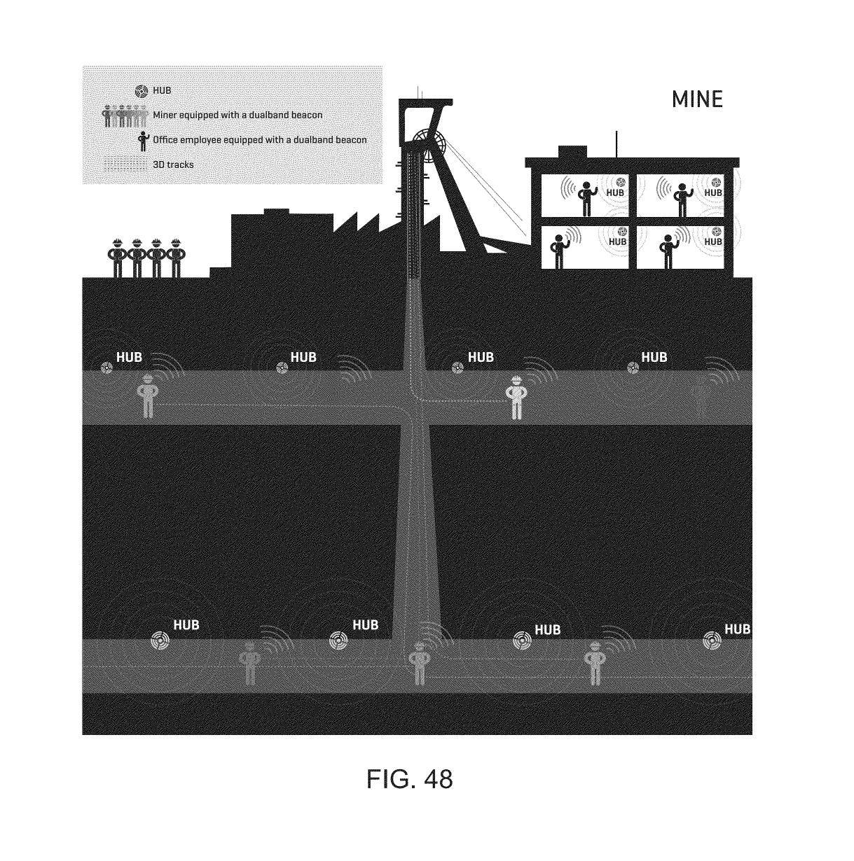

Yet another example use case of dual wide band (Ultra wide band+Bluetooth smart) beacons is shown in FIG. 48 which depicts a system of smart hubs used in a mine. Smart hubs can be placed in a mine as shown in FIG. 48. Miners are also equipped with the dual band beacons, such that at the surface of the mine, the miners' locations and environmental conditions can be tracked.

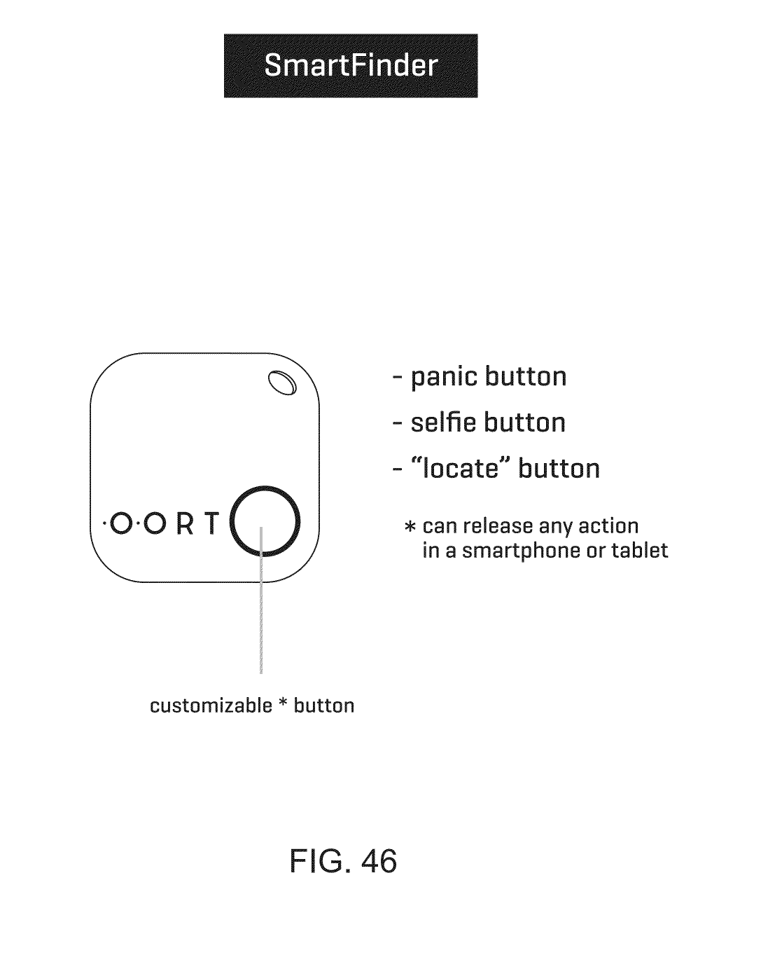

Systems of the present technology make use of a hub and beacons/wearable devices. Examples of smart devices include, but are not limited to personal tracking and panic buttons (which are depicted in FIG. 46) for hospitals, beacon system for libraries, beacon system for retailers, anti-theft beacon systems, smart toys, HUB+beacon+sensors (temperature, accel, humidity, light, noise), beacon interactive board games, smart garage doors and blinds which make use of beacons and other Bluetooth devices (eg. Bluetooth speaking system in a car), dualband beacons: Bluetooth+UWB=hyperconnectivity+accurate 3D location, universal beacon for electronic devices (lamps, coffee machines), universal beacon for mechanical devices (garage doors, blinds), wristband/beacon with accelerometer as a control device for computers (gesture control), software (power point, OS), smart devices (quadrocopter, smart home) or wearable devices (Google glass), wearable devices (jawbone, Fitbit, Nike fuel) as a trigger for smart home, customizable beacons, beacon traffic monitor systems, weather and air quality monitoring system which makes use of Bluetooth and smart sensors, personal safety beacon system. Use cases: skiing areas, mines, building sites, smart pot cover with smart sensors, geolocation system for smart HUB and smart and wearable devices, and beacon smart sensors system for greenhouses.

As shown in FIG. 46, exemplary devices that practice aspects of the present invention include actuator devices which comprise buttons which can be pressed manually by a user in a variety of ways (such as for a period of time, a sequence of buttons or a number of presses to actuate any action on a tablet or smart phone). For instance, the buttons on the device may be customizable buttons which can release or actuate any action on a tablet or smart phone. The button could be a selfie button which when pressed will cause a tablet or smart phone to take a photograph of the user. The button could be a locate button that helps a user to locate a physical object such as a smartphone. A user can press the locate button to cause the smartphone to make an audible sound or ring to signal its location. The button can be a panic button that when depressed, the user's smart phone or tablet will email or text a designated contact with a message such as “I'm in trouble” including a pin on a web based map to show the user's location. The actuator device can cause actions to come through the smartphone or a hub in the cloud. Thus, if a hub is within the actuator device, the hub can also react. The button on the device can be customized such that if a user is at home and wishes to turn off the lights, the user can press the customized button which will cause the hub to release the action that you configured before (such as by turning off the lights at home). Thus, the actions can come through the smartphone or a hub in the cloud.

It will be understood that in some embodiments, air quality sensing may enable remote temperature measurement from indoor and/or outdoor thermometer sensors, or other types of meteorological sensors such as barometers.

In addition to the description provided below, further details regarding the present technology can be found in the Figures, which are attached hereto and are hereby incorporated by reference herein in its entirety, including all references cited therein.

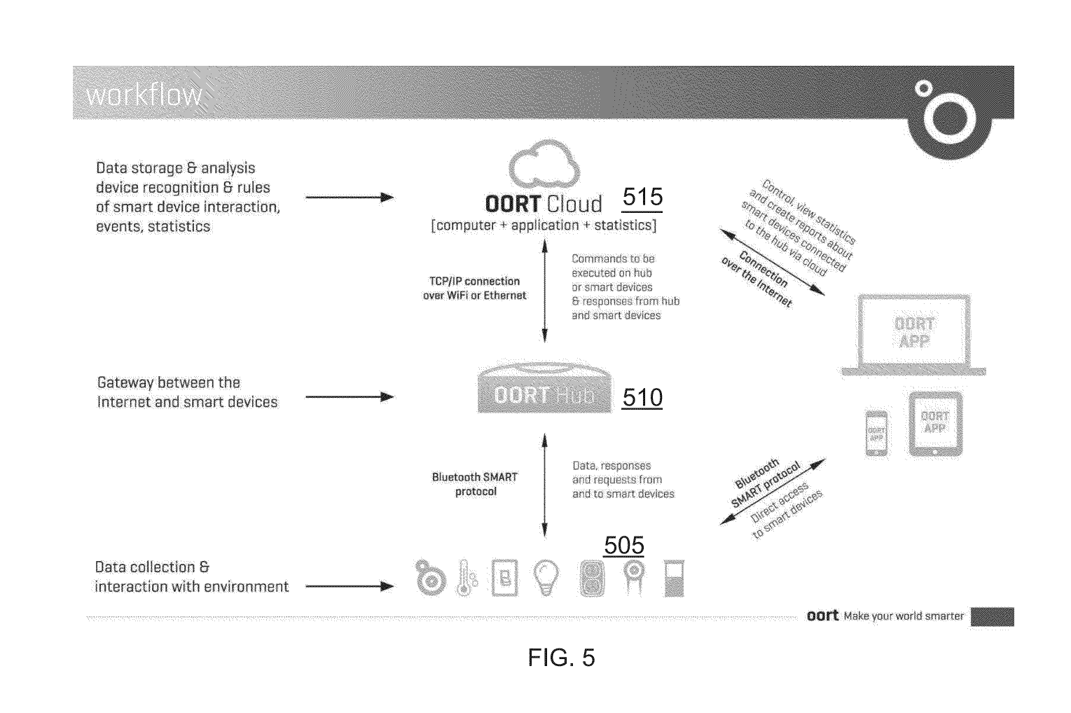

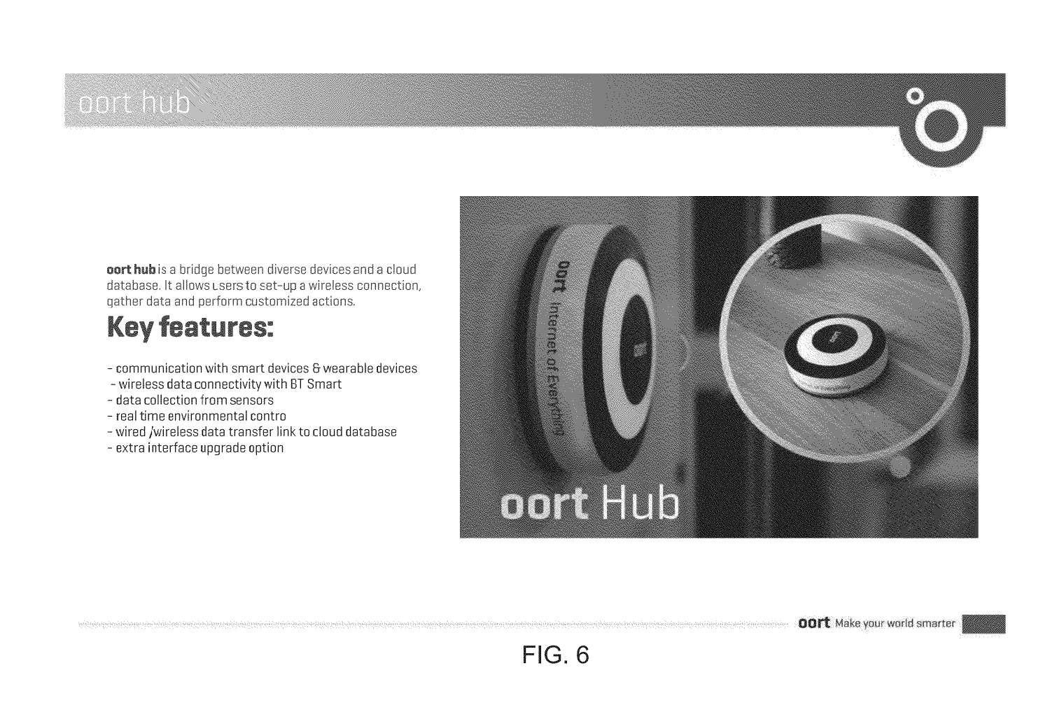

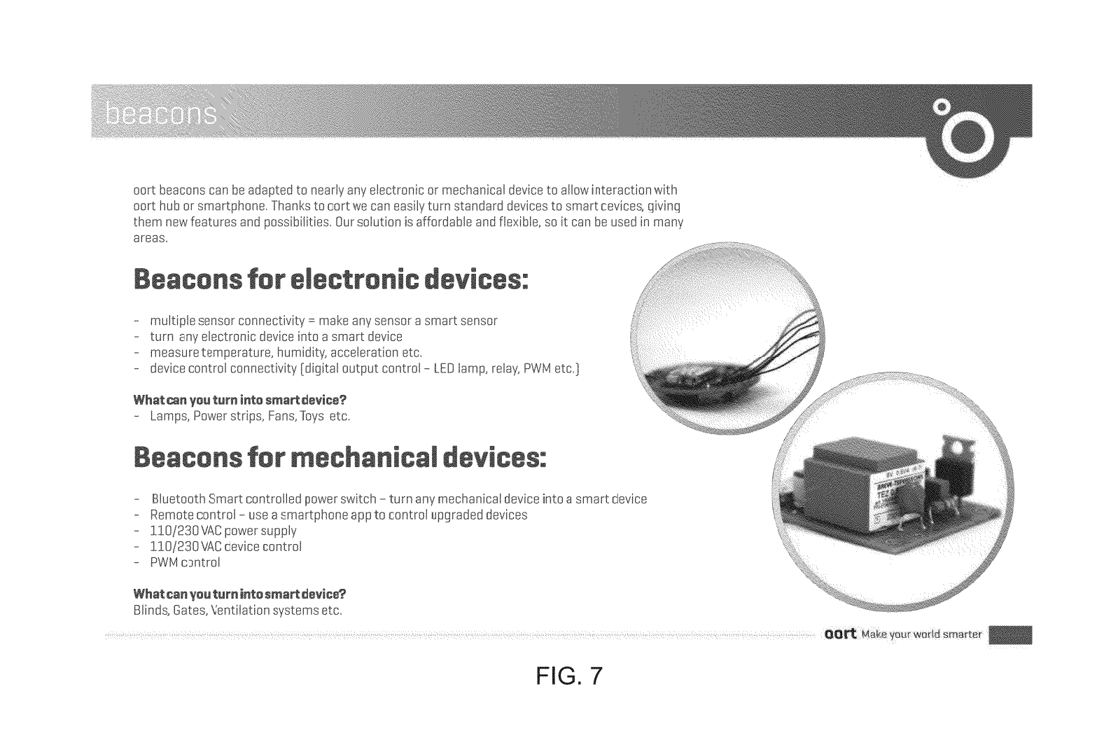

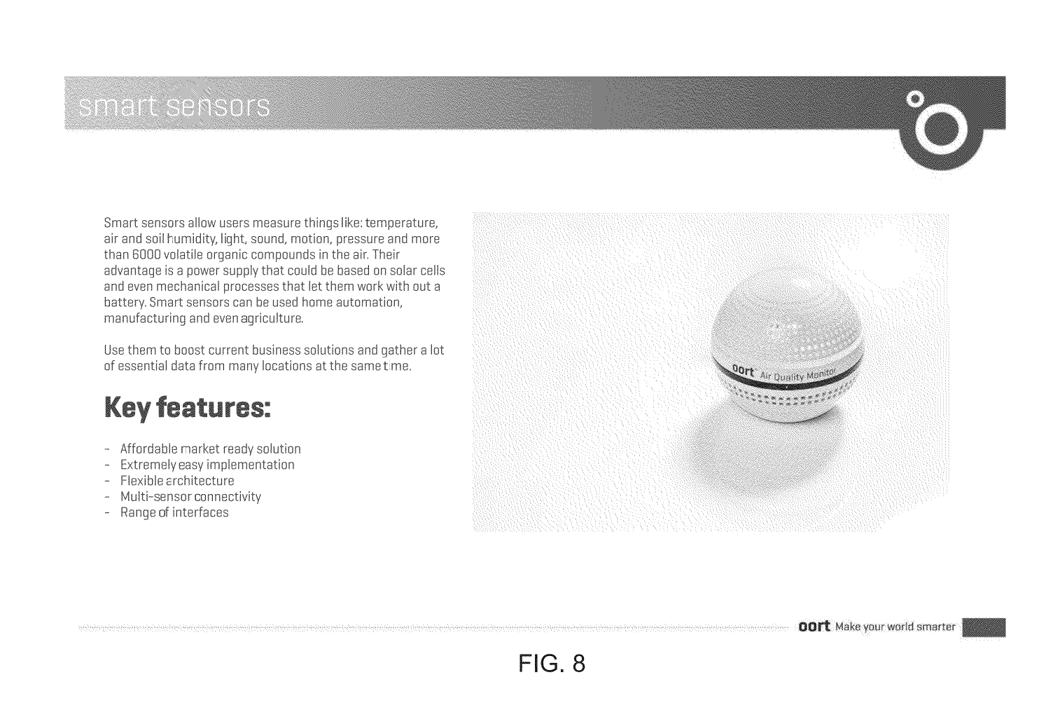

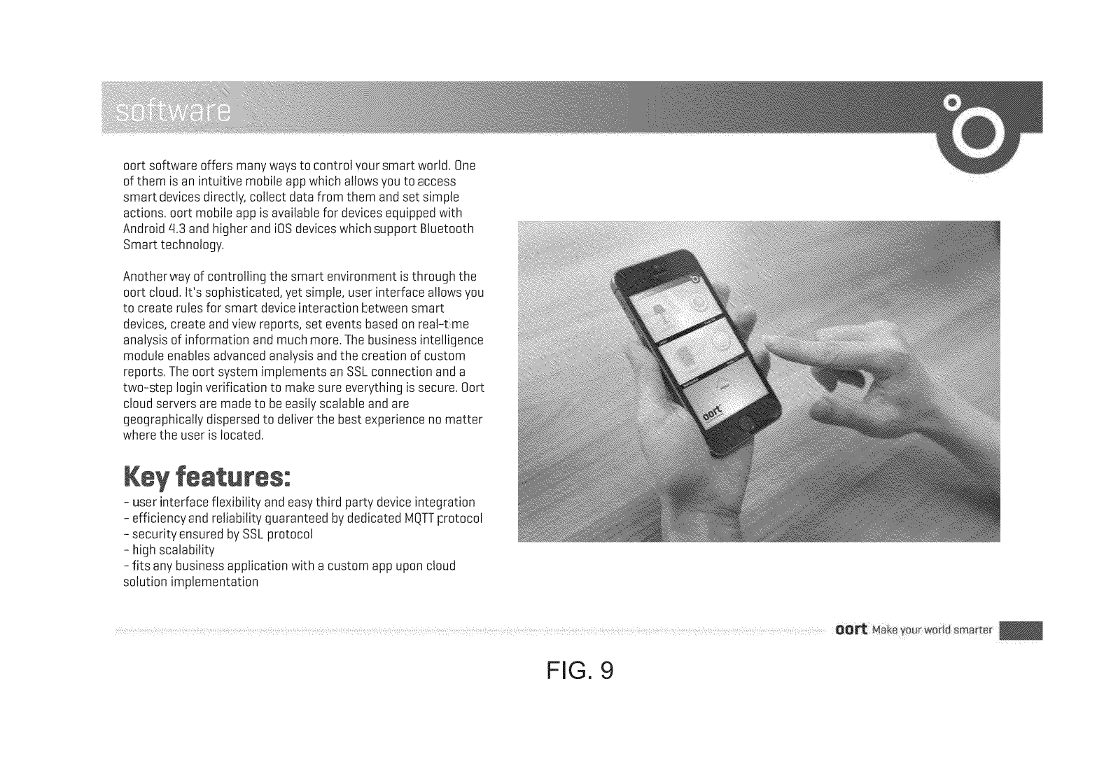

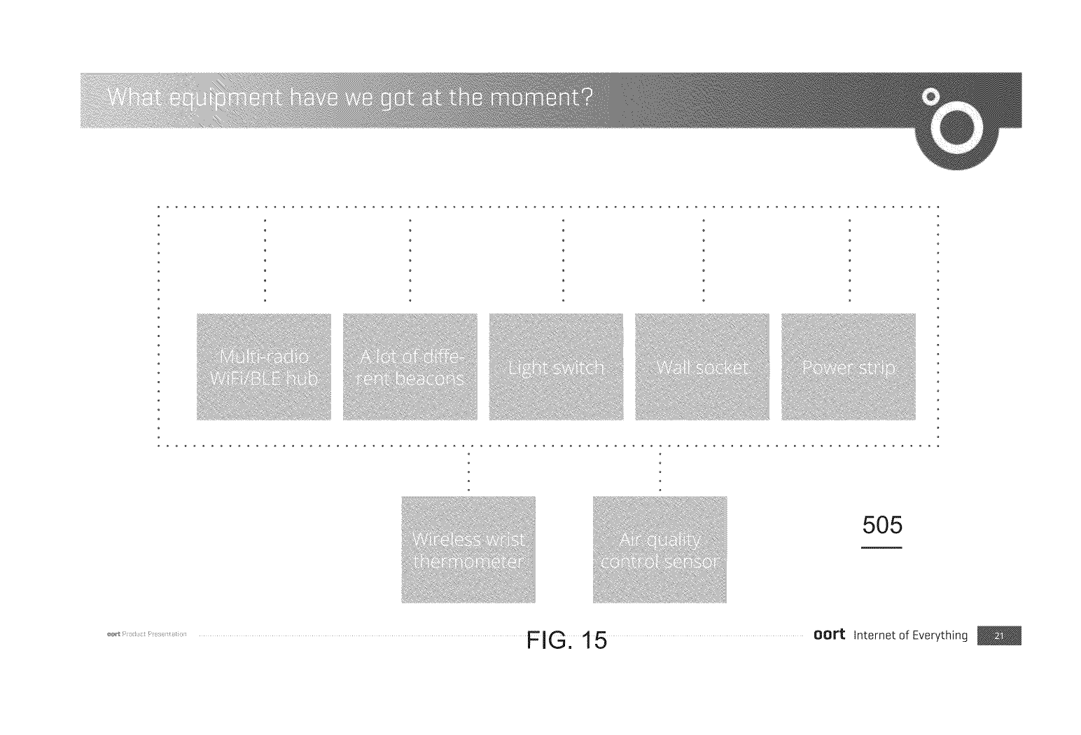

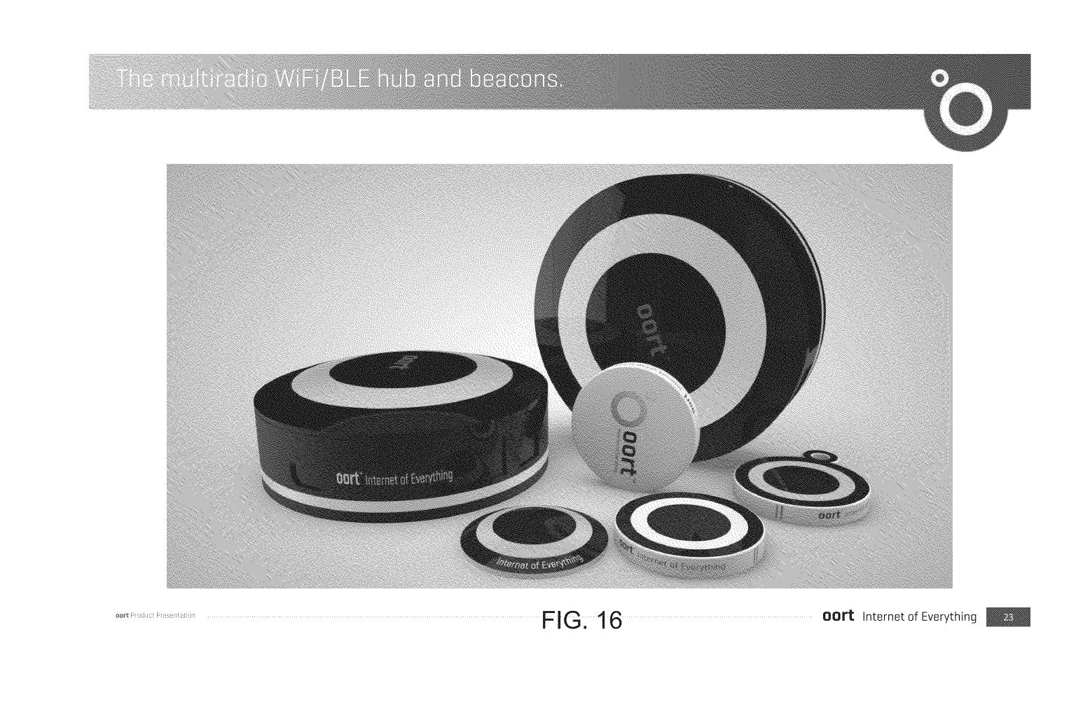

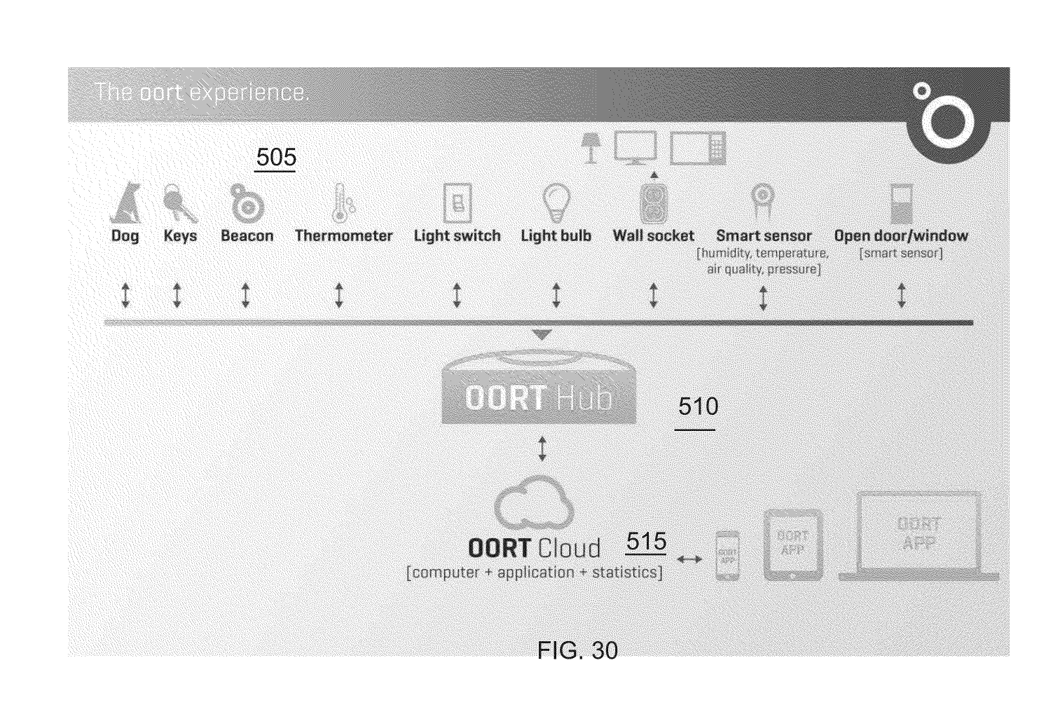

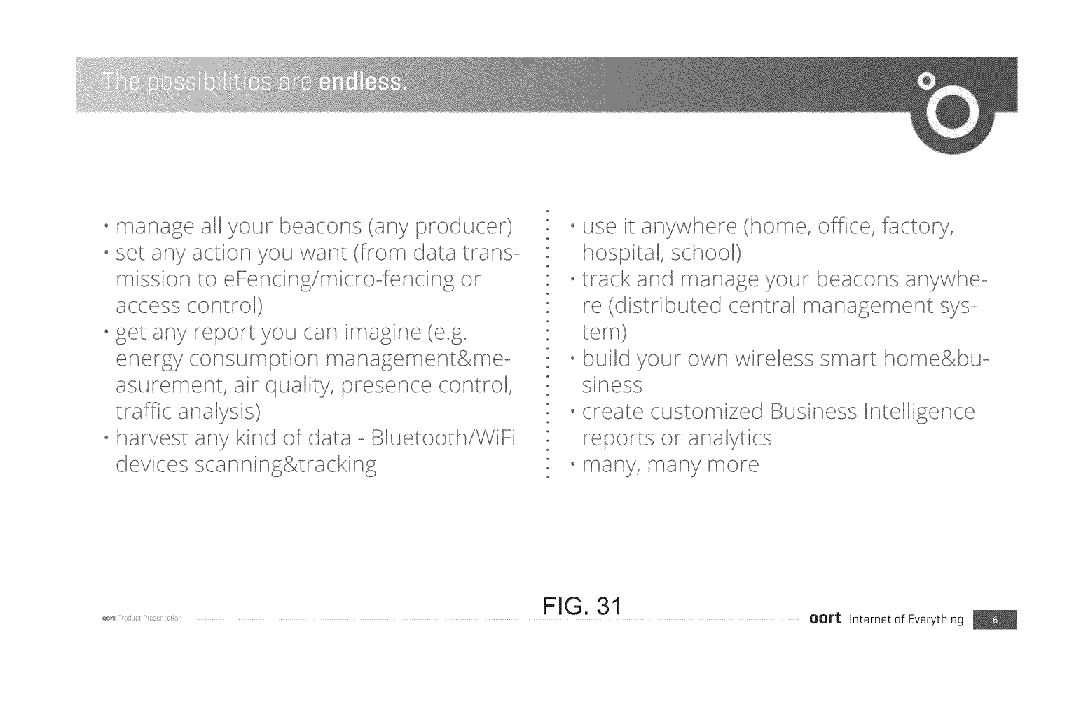

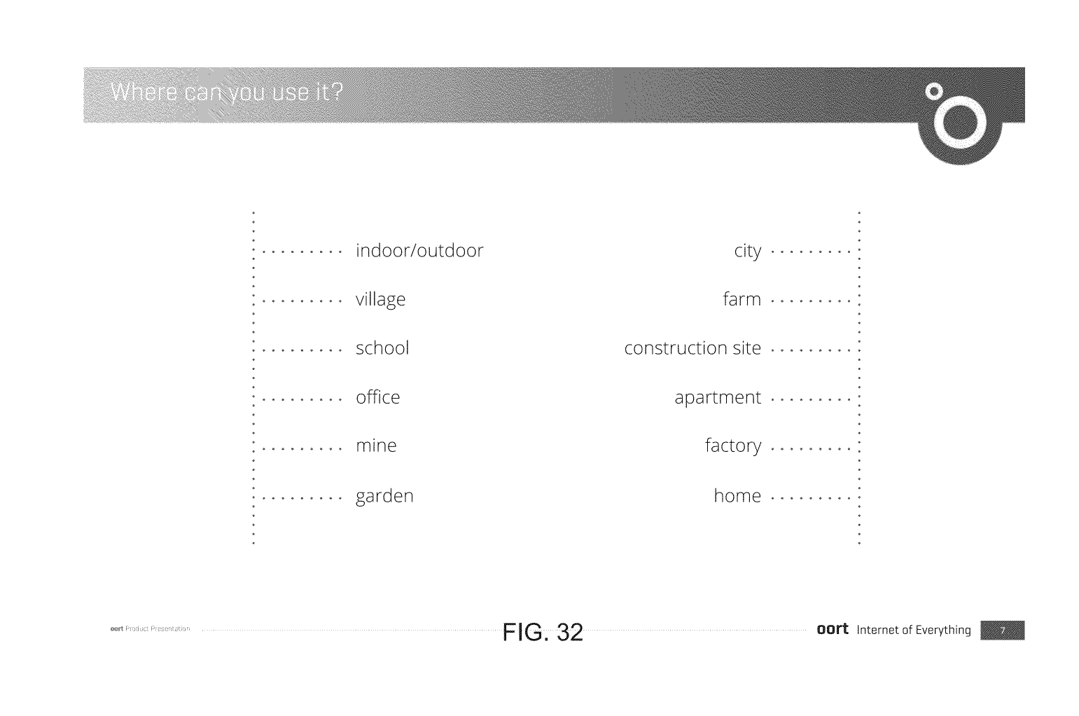

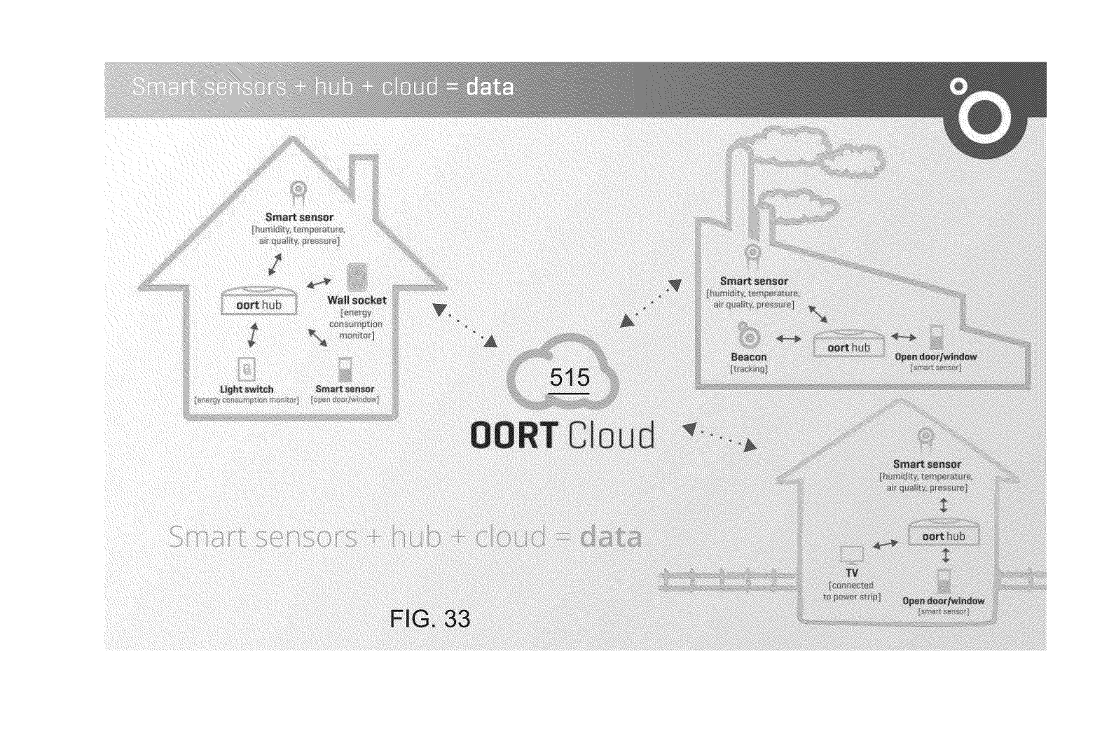

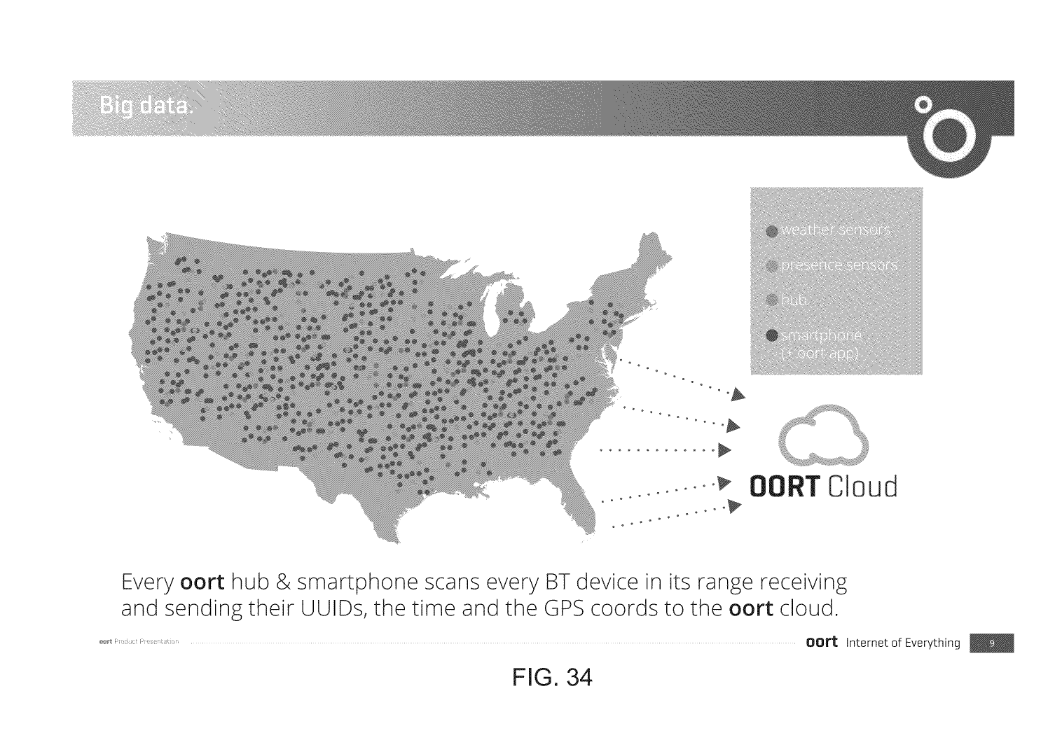

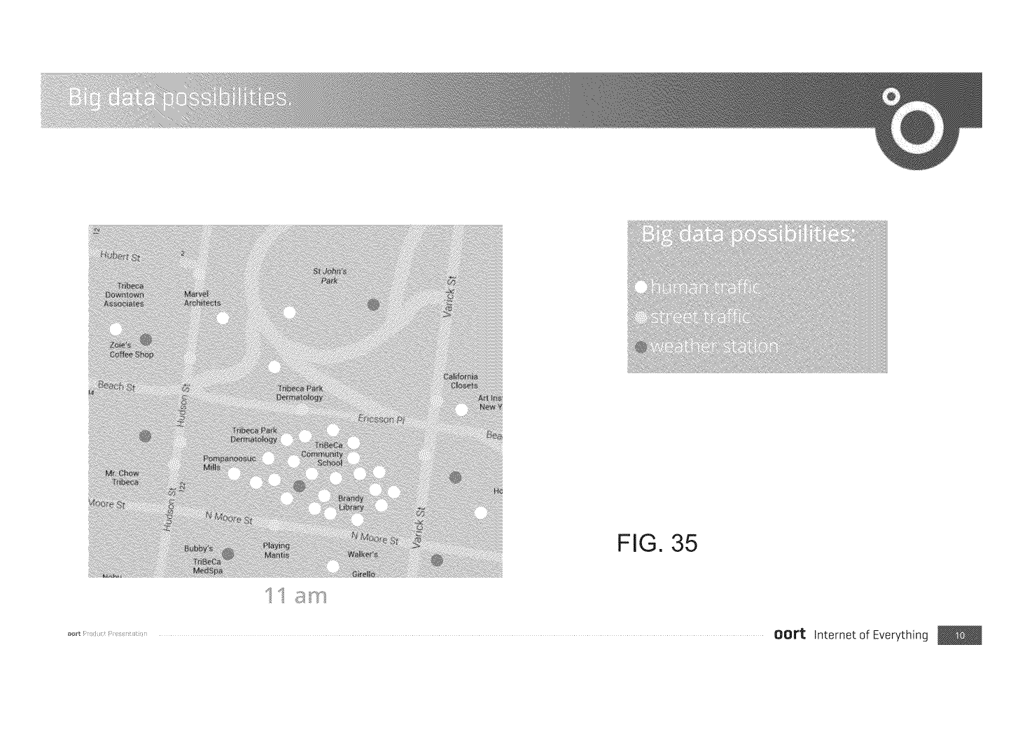

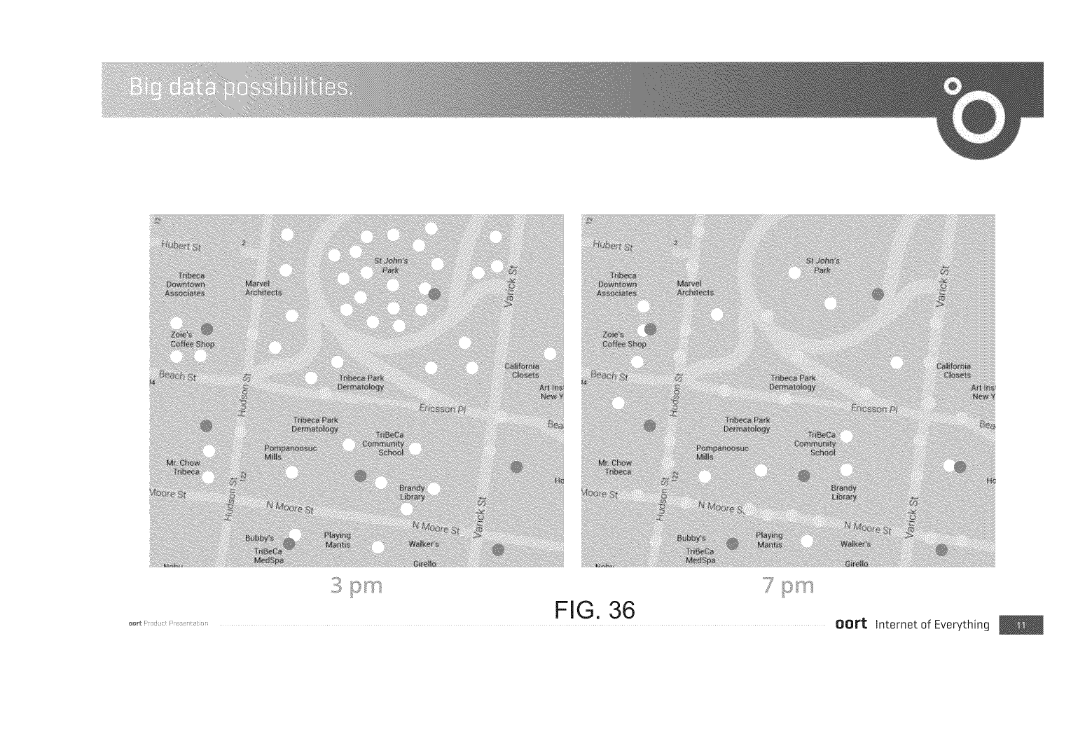

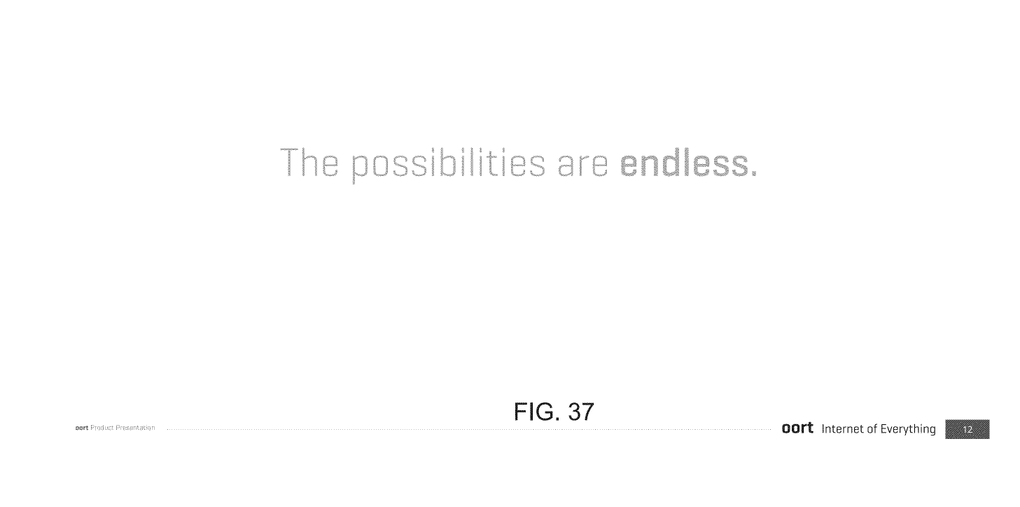

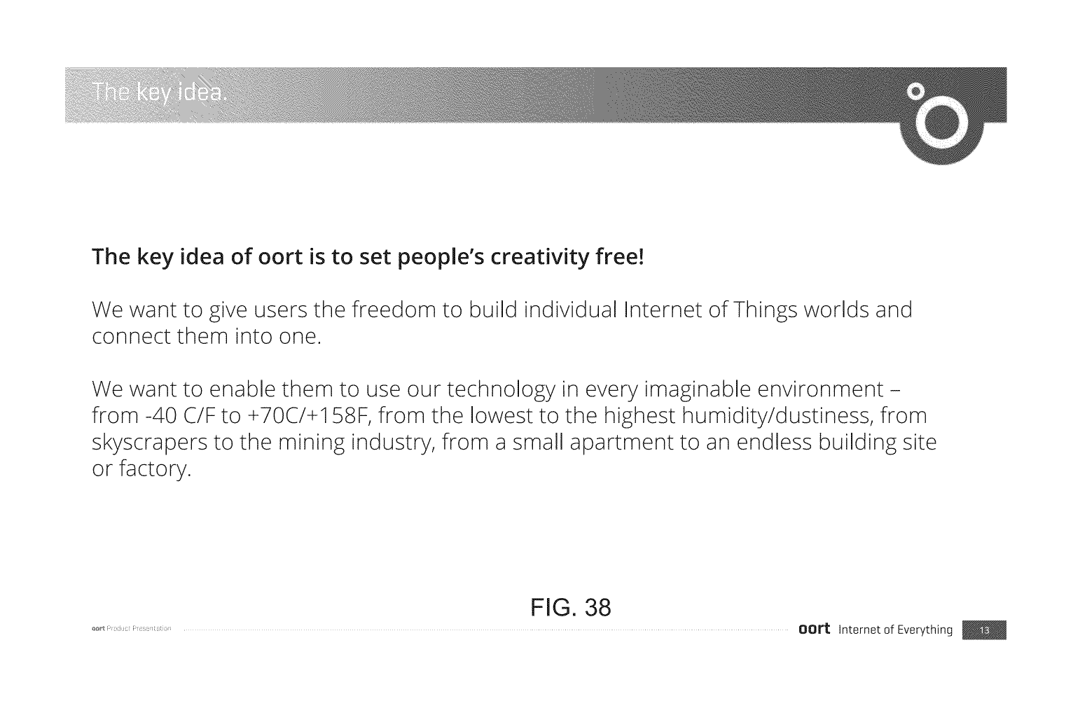

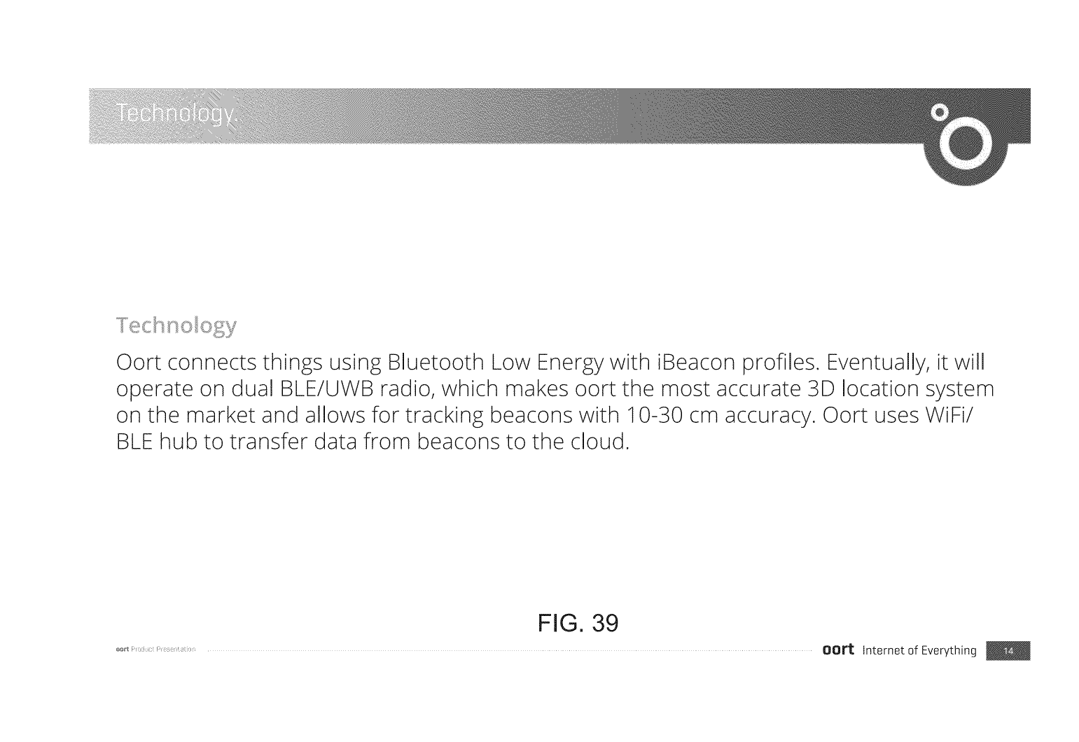

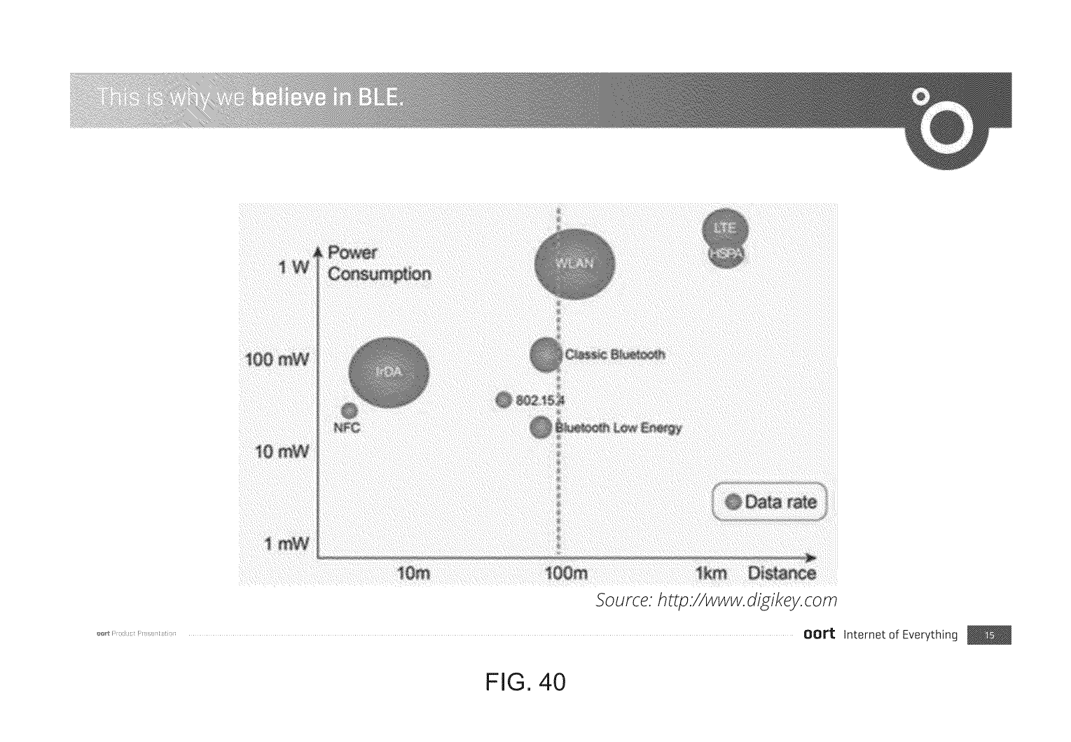

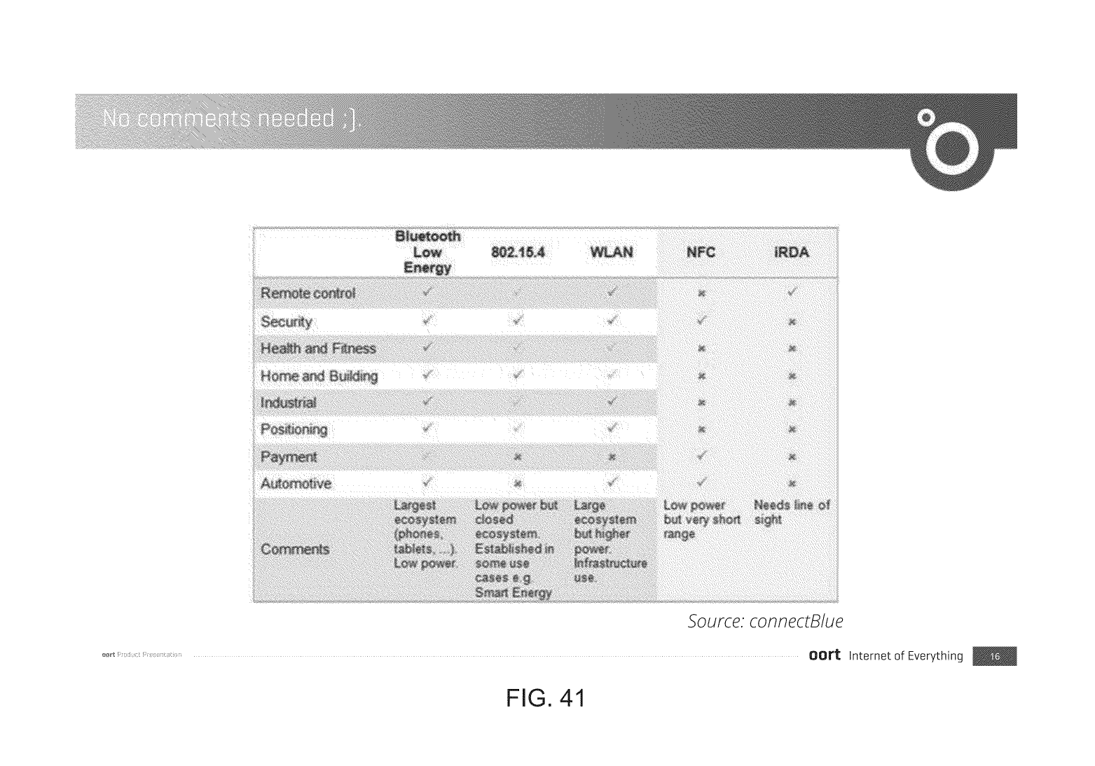

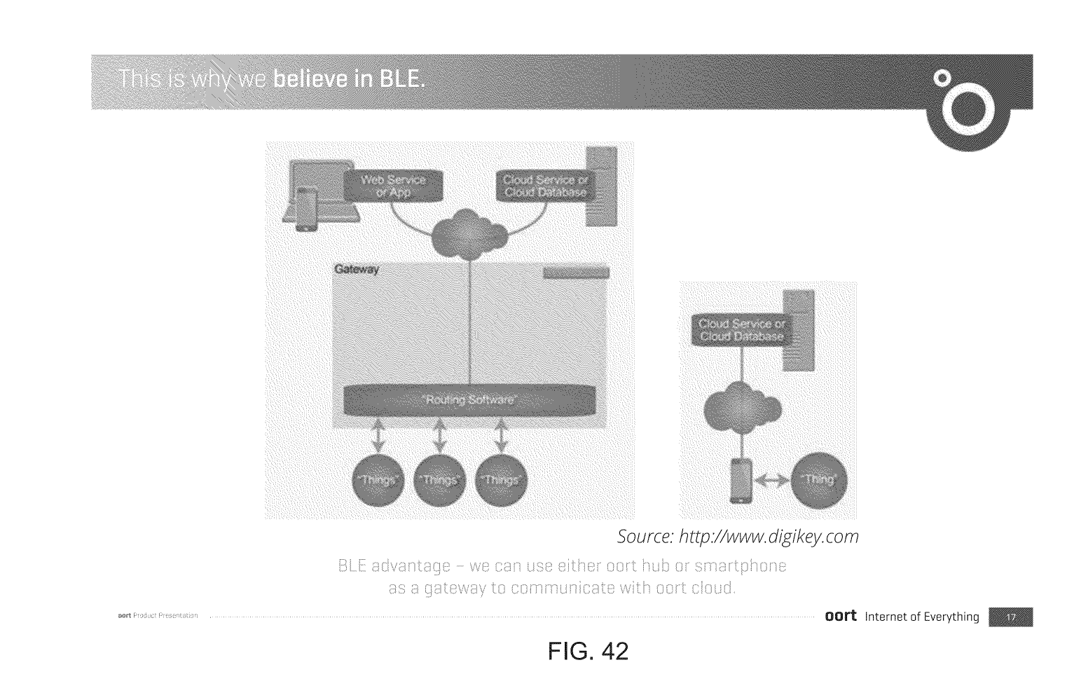

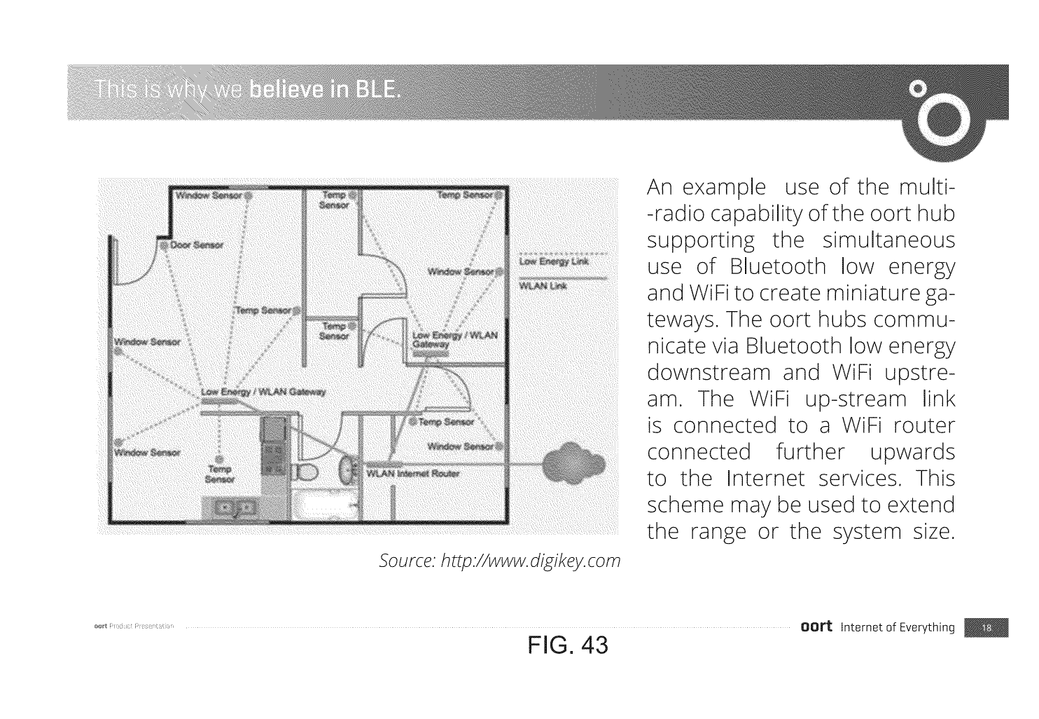

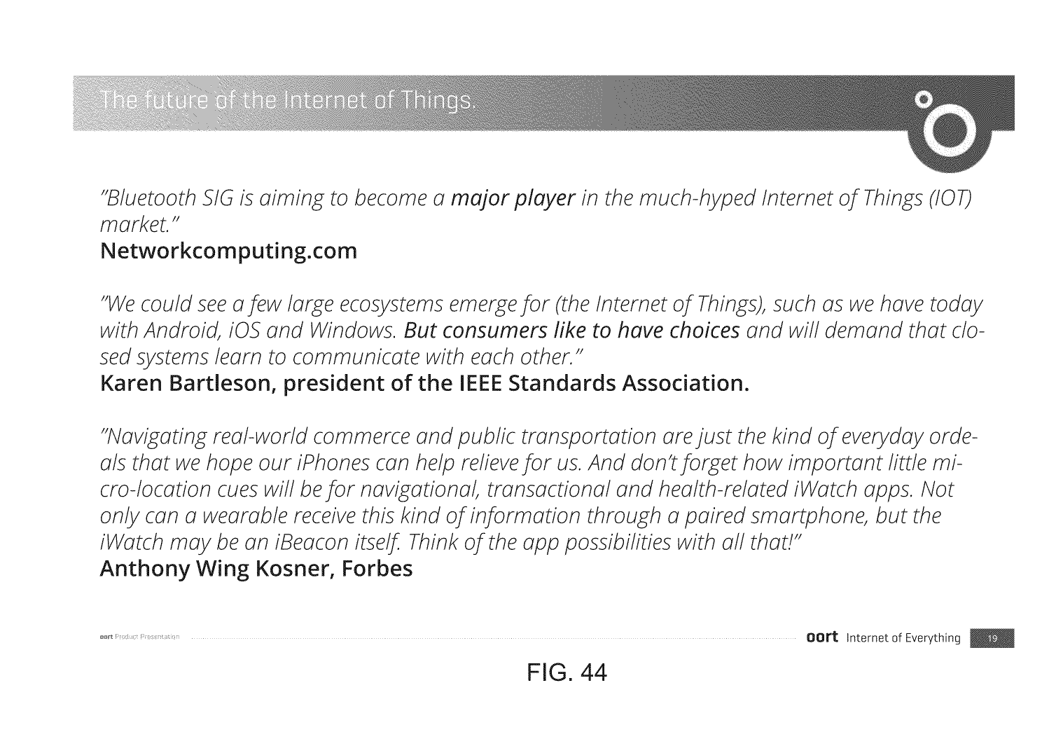

FIGS. 5, 15, 30, 33, and 42 illustrate example systems that can be used to implement the present technology. For example, in FIG. 5, a system 500 comprises beacons 505, a hub 510, and a cloud 515. Generally a beacon is any physical device that capable of being controlled, monitored, and/or actuated electronically. Examples of beacons include, but are not limited to, televisions, thermostats, computers, large and small household appliances, light switches, light fixtures, electrical outlets, electronic gates and doors, smart sensors, windows, as well as many other types of physical objects that would be known to one of ordinary skill in the art. In sum, any electronic or mechanical device can be converted into a smart device using a beacon of the present technology.

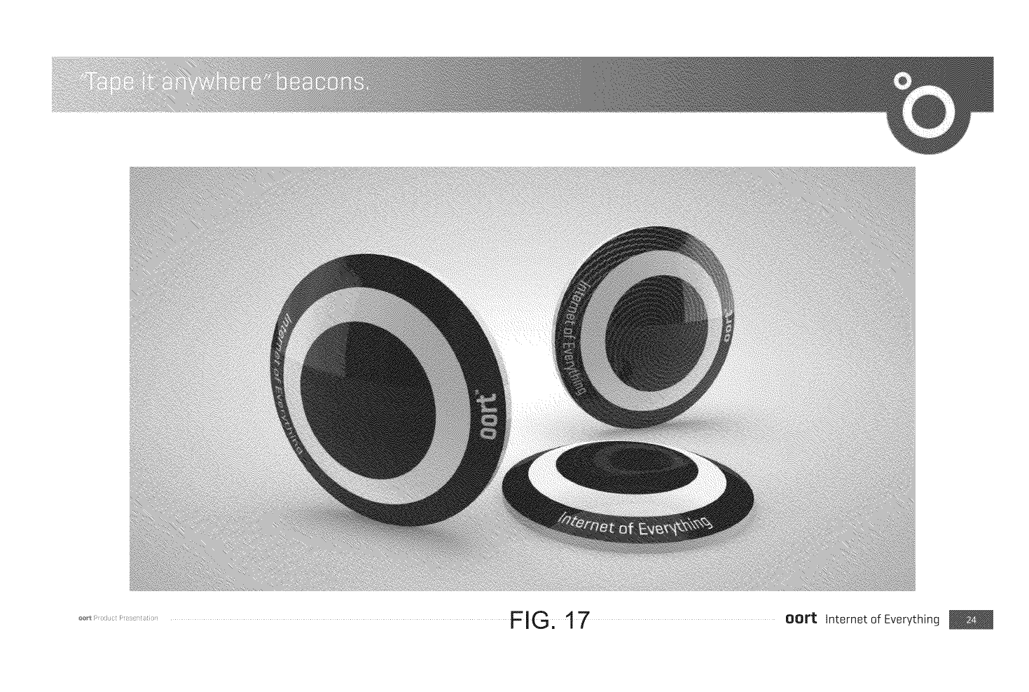

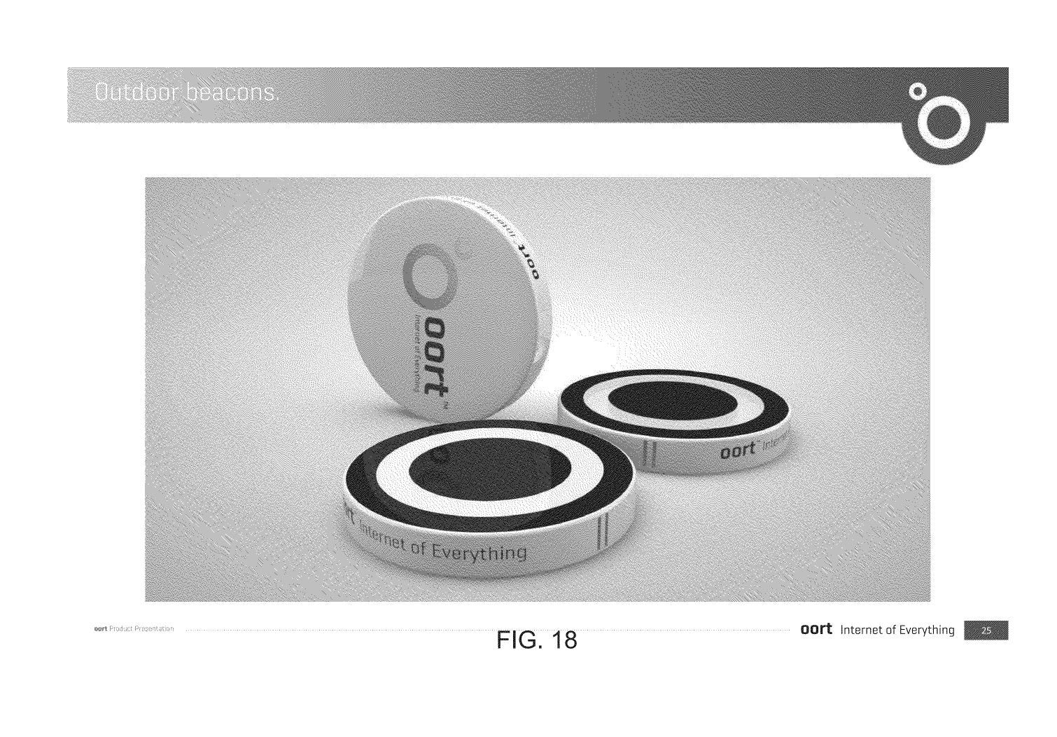

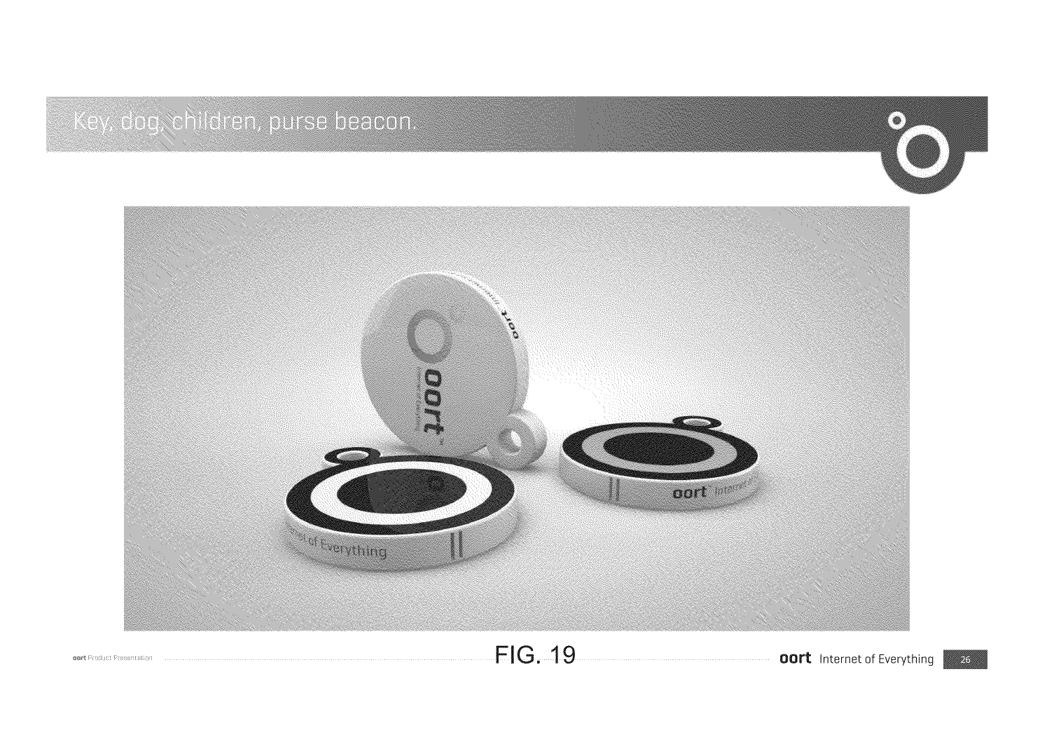

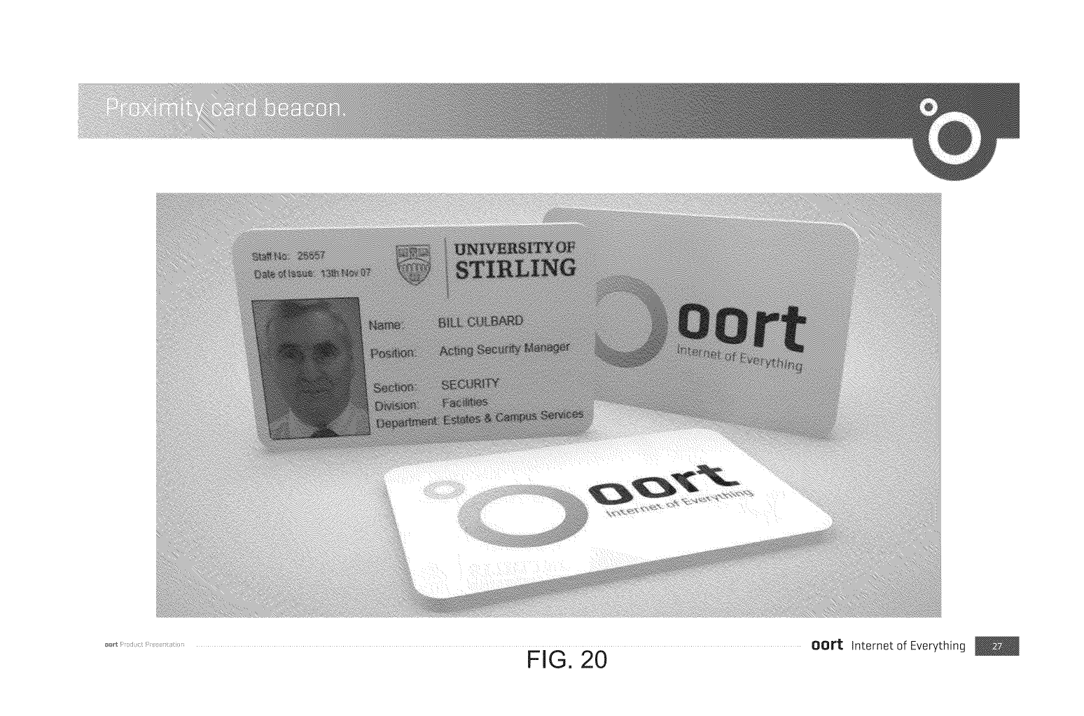

Also, a beacon can include other types of physical objects include people, buildings, establishments, animals, and other physical objects that cannot be electronically controlled. These types of physical objects can be tracked using a beacon of the present technology, which is associated with the physical object (see FIGS. 17 and 19). In one example, a dog's collar can be associated with a beacon. The dog can be tracked using the beacon. Beacons can be placed on a child's backpack, a key, a computing device, or any other physical device that is desired to be tracked. The tracking of these types of device will be described in greater detail below.

Each of the beacons 505 uses Bluetooth Low Energy/Ultra Wide Band (BLE/UWB) protocols and interfaces. That is, each of the beacons 505 integrates or is associated with a BLE/UWB interface that allows the beacons 505 to communicatively couple with the hub 510. Other similar communication protocols can also be likewise utilized in accordance with the present technology.

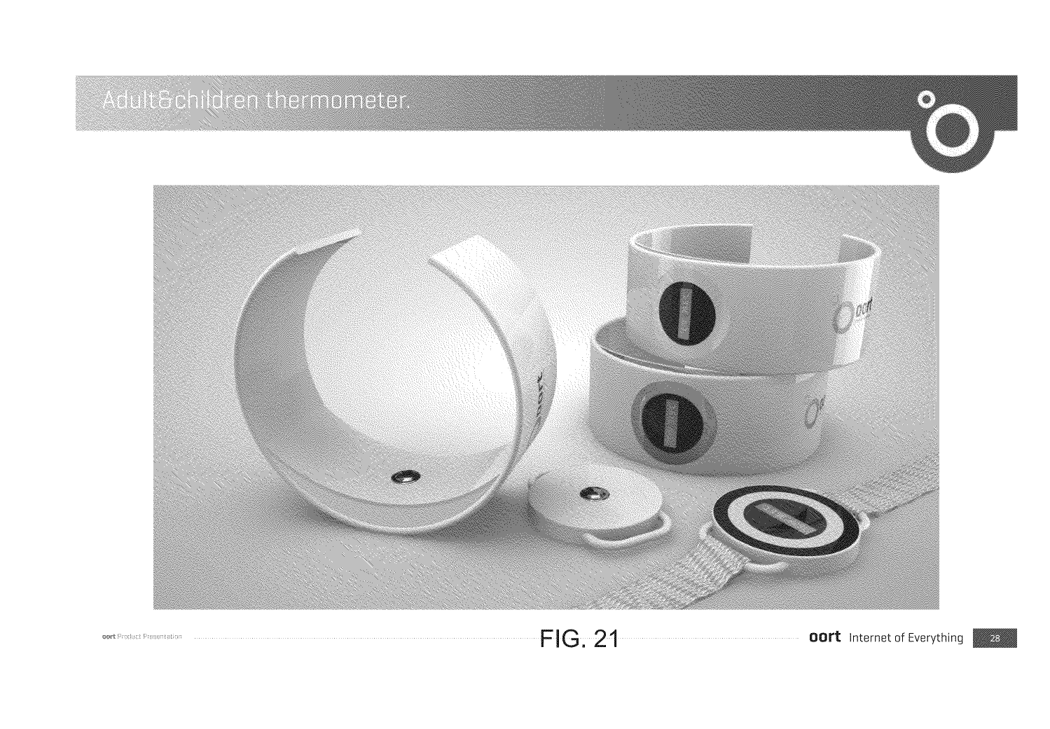

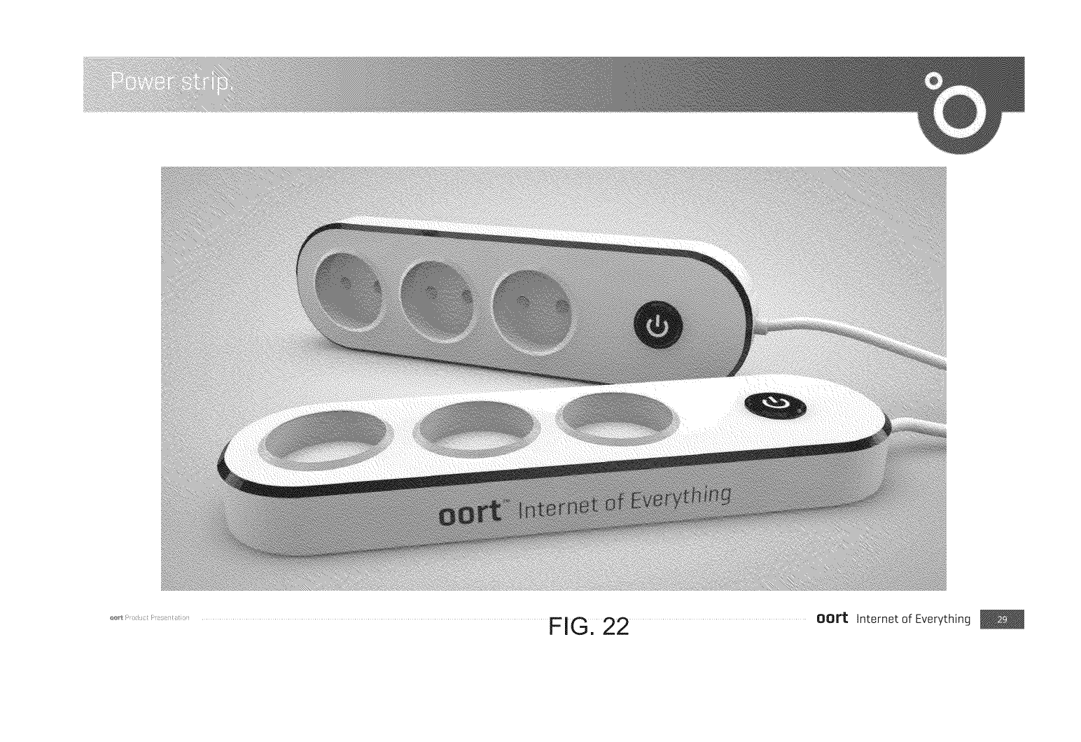

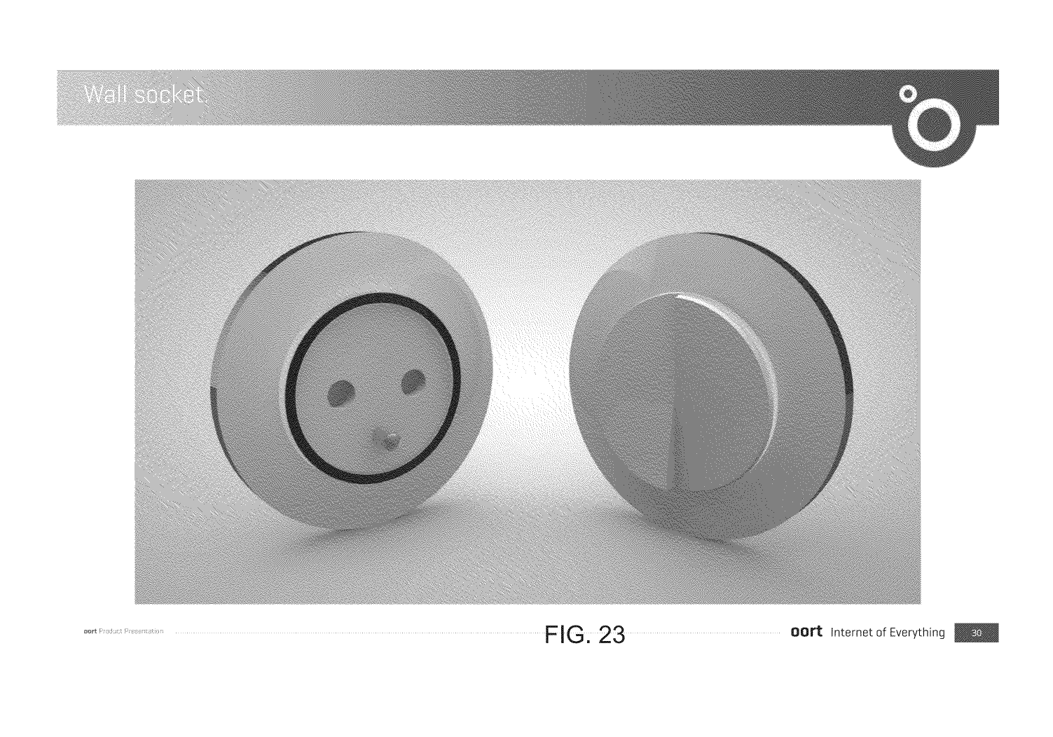

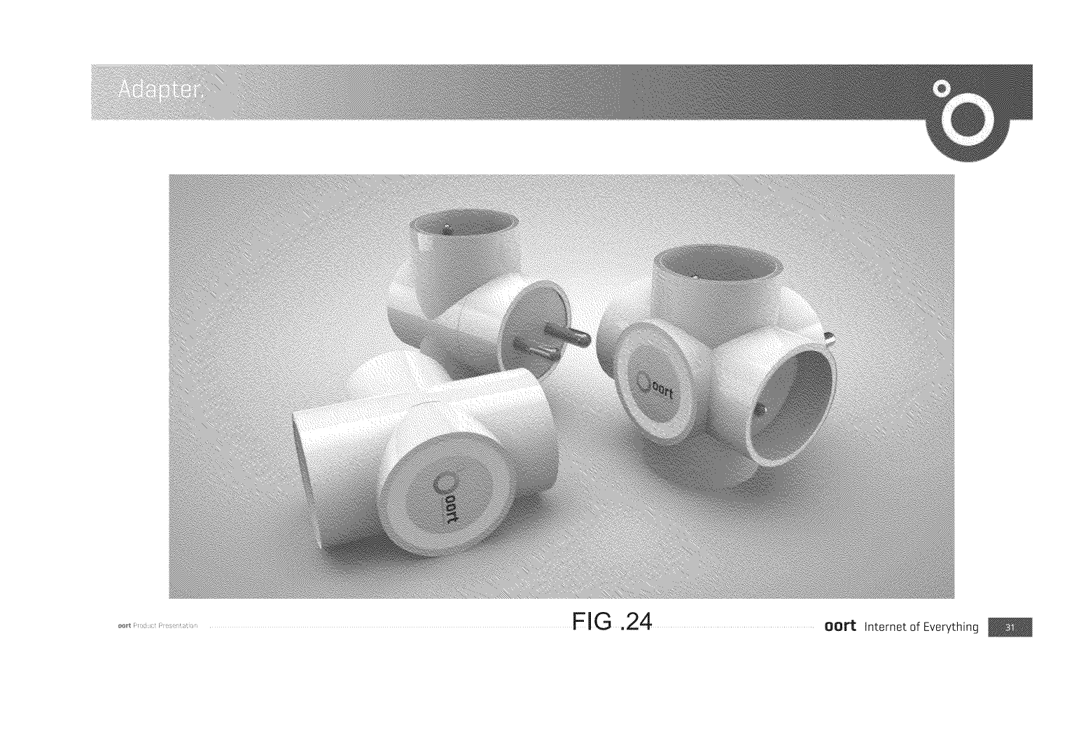

In some instances, a beacon can include a device that electronically couples with a target device/physical object. For example, in FIG. 22, a beacon in the form of a power strip can be used to control power provide to a television or other appliance. The power strip can be used to switch the appliance on and off. FIG. 21 illustrates beacons than can be worn by an individual. FIG. 24 illustrates a power adapter than can be used to control an electronic device. In FIGS. 22 and 24, the power strip and power adapter include the BLE/UWB interface. It is advantageous to use these types of beacons when the electronic device that the beacon couples with does not integrate a BLE/UWB interface.

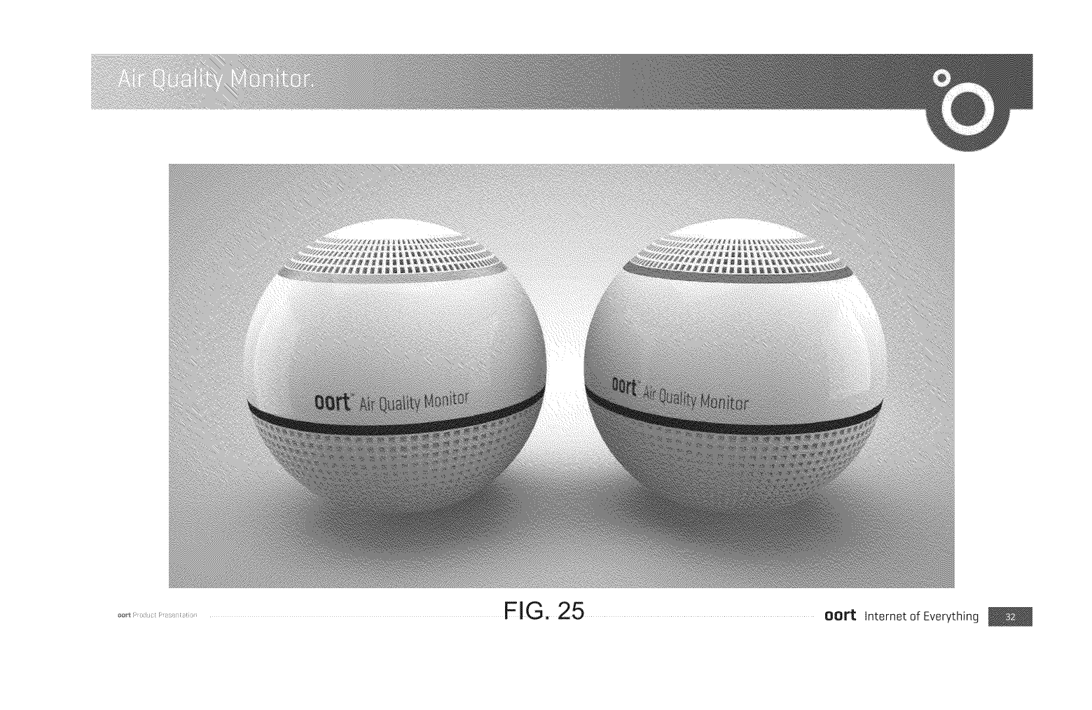

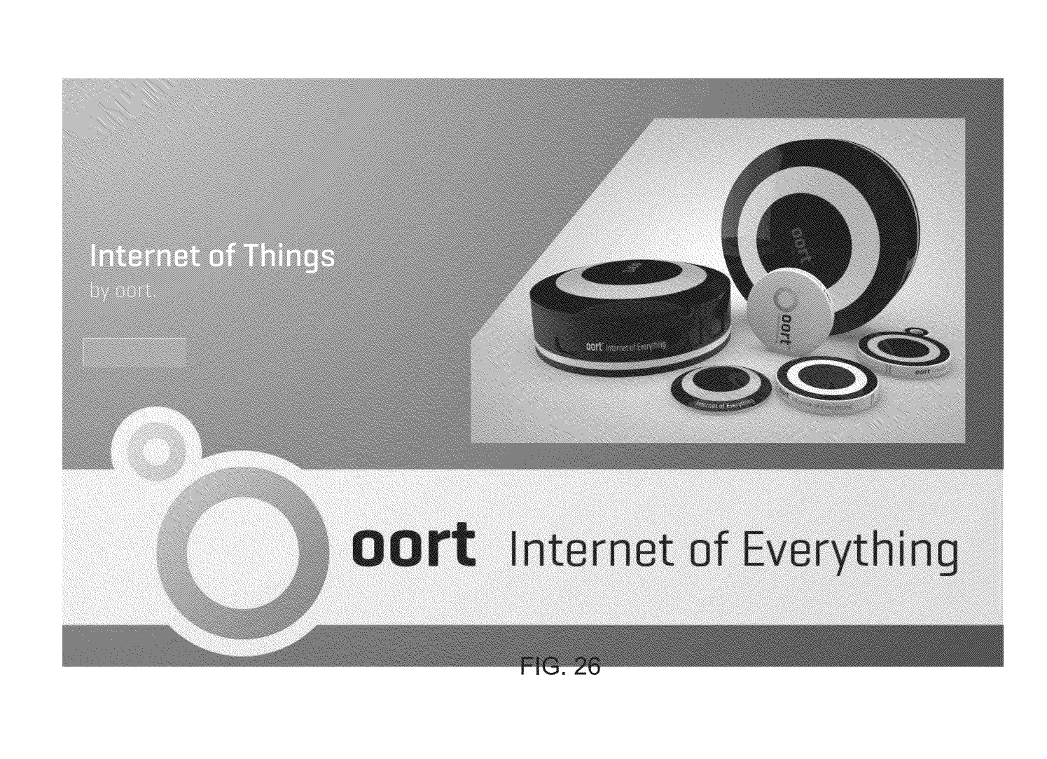

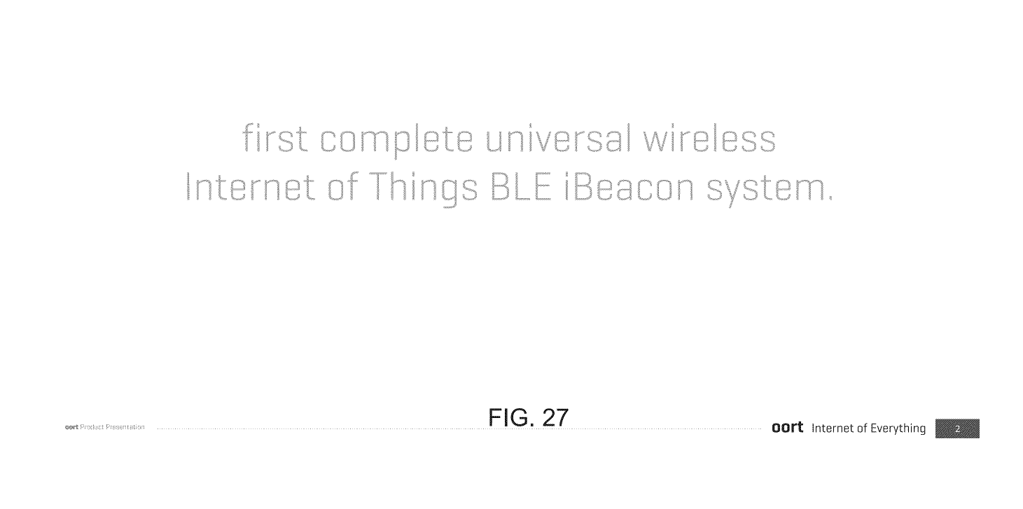

FIG. 25 is an example air quality monitor, which is a self-contained monitor/sensor that integrates a BLE/UWB interface.

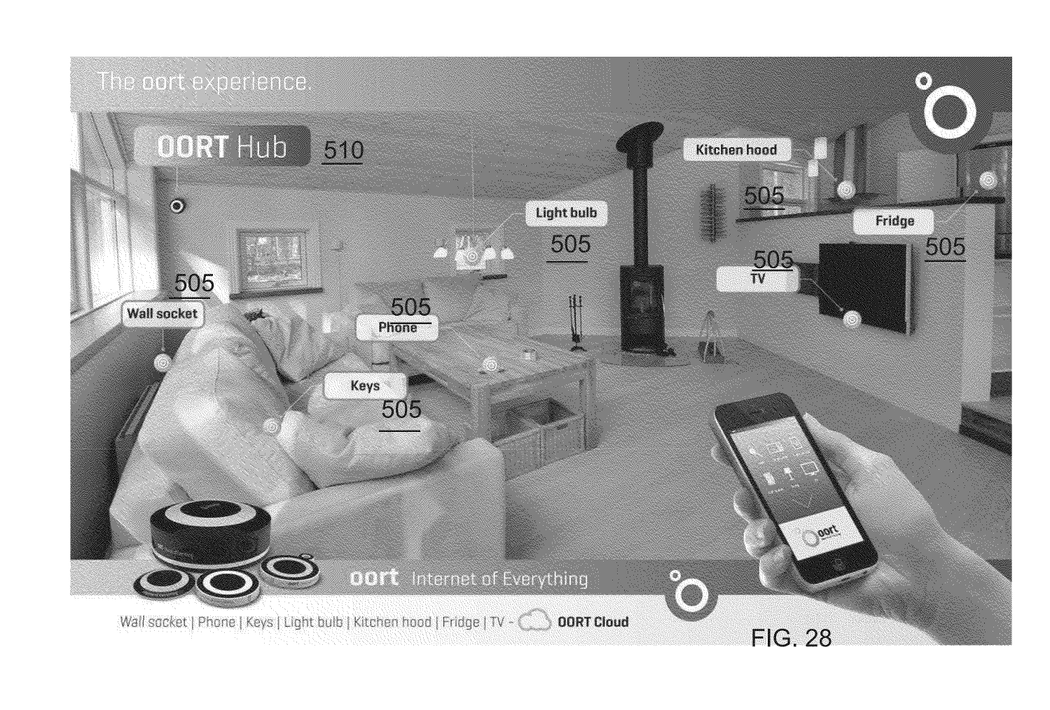

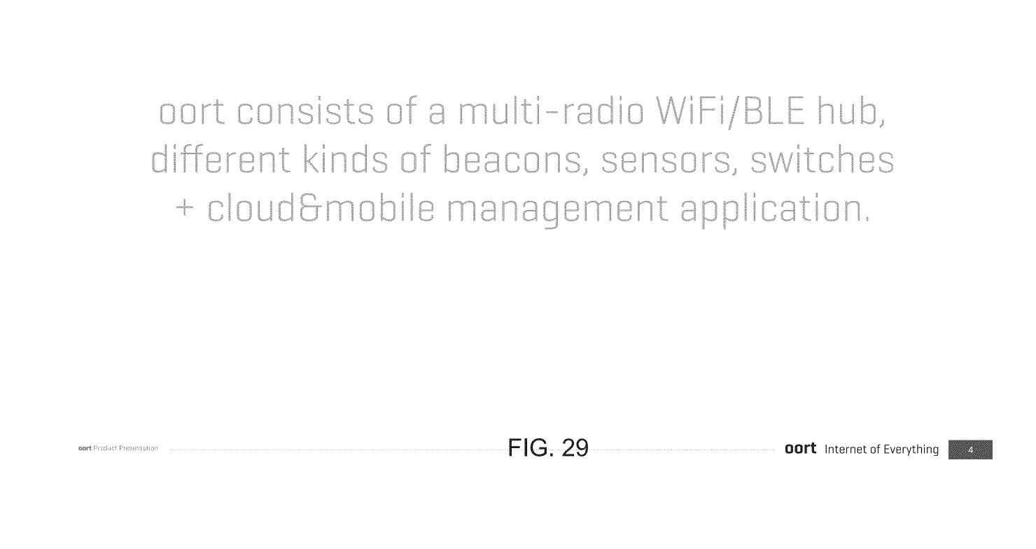

The hub 510 is a computing device that is configured to monitor and/or control each of the beacons 505 that are in proximity to the hub 510. FIG. 28 illustrates a hub 510 and a plurality of beacons 505 dispersed throughout a room. The hub 510 allows a user to track the location of each beacon. For example, a beacon attached to car keys can be used to locate the car keys in the room.

The hub 510 can also communicatively couple with the cloud 515 to store data generated by the hub 510 monitoring the beacons 505. That is, each of the beacons 505 can be transmit signals to the hub 510 that are indicative of the operation of the beacon itself or the device to which the beacon is coupled. The data generated by the beacon and its associated device is stored in the cloud 515 and can be accessed on an as needed basis to generate reports for the end user. The hub 510 can, in some embodiments, communicatively couple with the cloud 515 using a WiFi access point for the room. The hub 510 can communicate with the cloud using Wi-Fi, Ethernet or GSM network.

Other suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 1220 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The hub 510 can be programmed with logic that allows the hub 510 to monitor and control each of beacons and/or beacon/device pairs in a room. For example, the hub 510 can monitor signals output by a beacon that is coupled with a television. The beacon can sense when the television is turned on and off, how long the television is used in a given day, how much power the television consumed, and so forth. The beacon can continually and/or periodically transmit signals to the hub 510 that provide one or more of these types of information. In another example, a beacon attached to car keys may periodically or continually output to the hub 510 a location signal. Thus, in the example room of FIG. 28, each electronic device or physical object coupled with a beacon can transmit to the hub 510 information that is used by the hub 510 to track, monitor, and/or control these devices or objects.

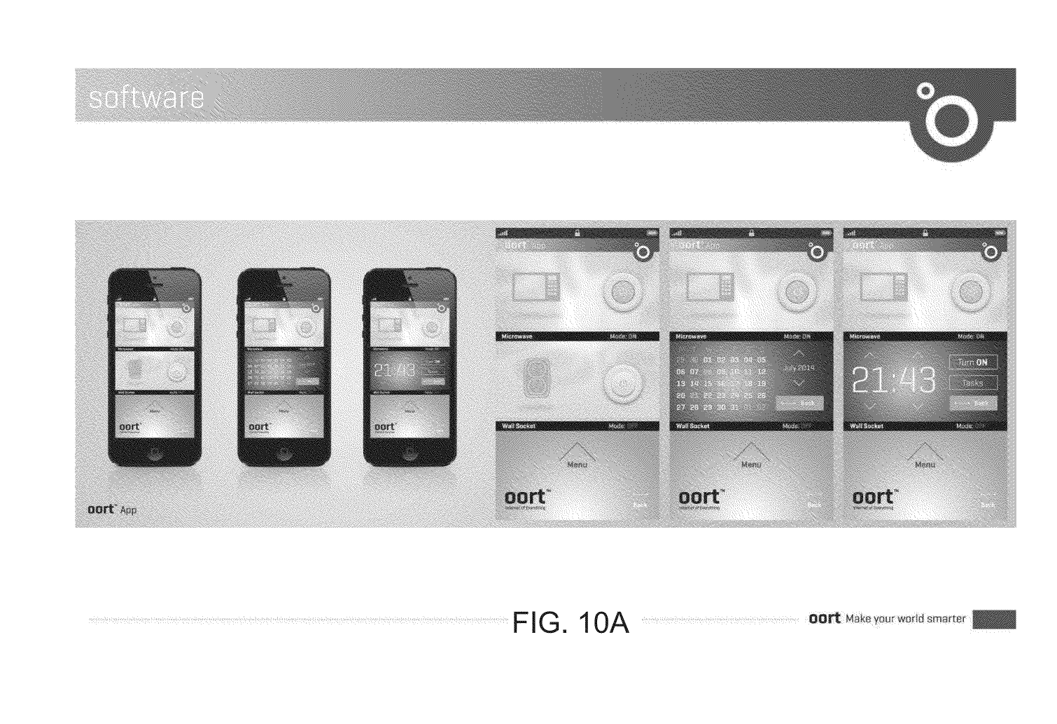

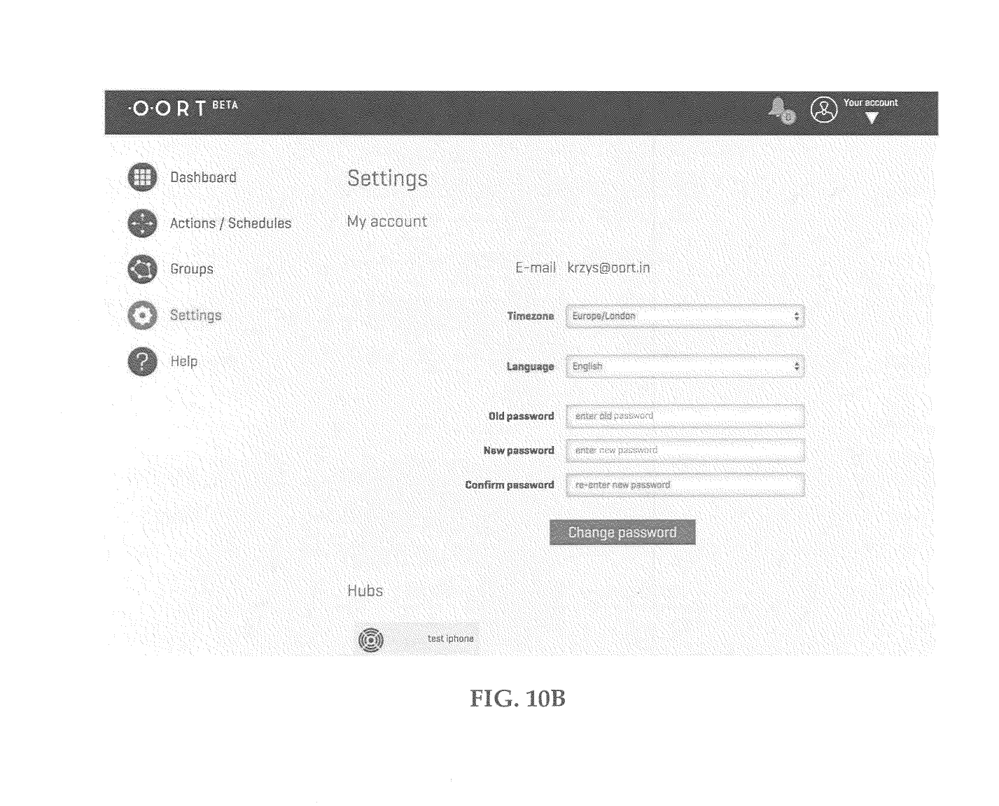

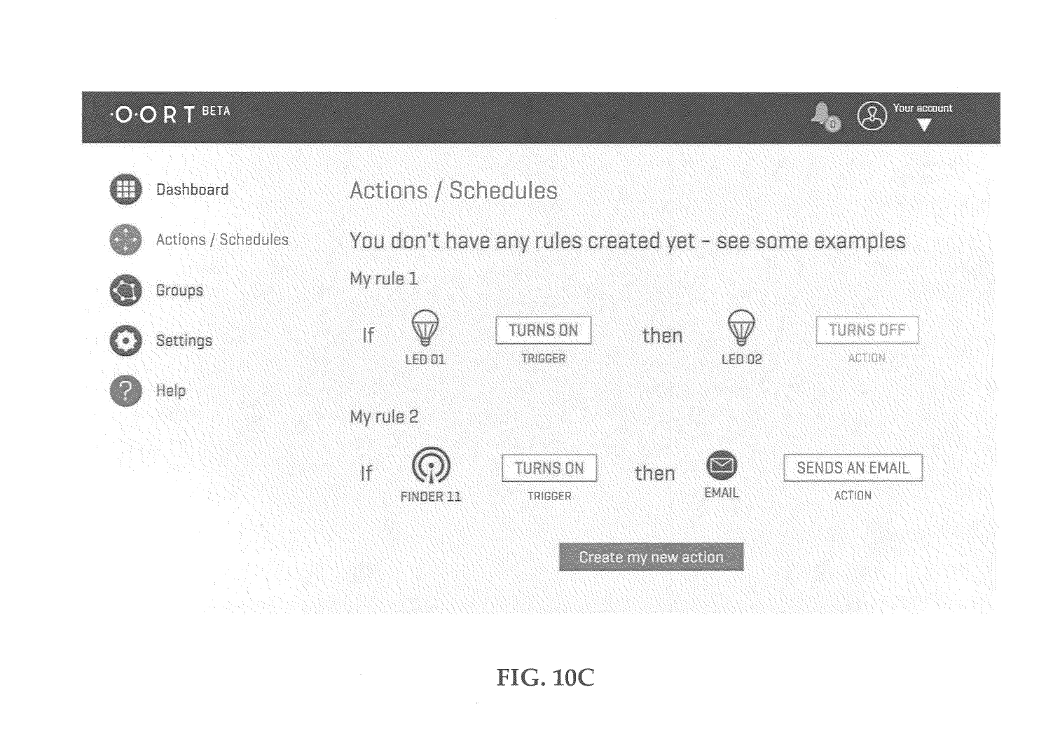

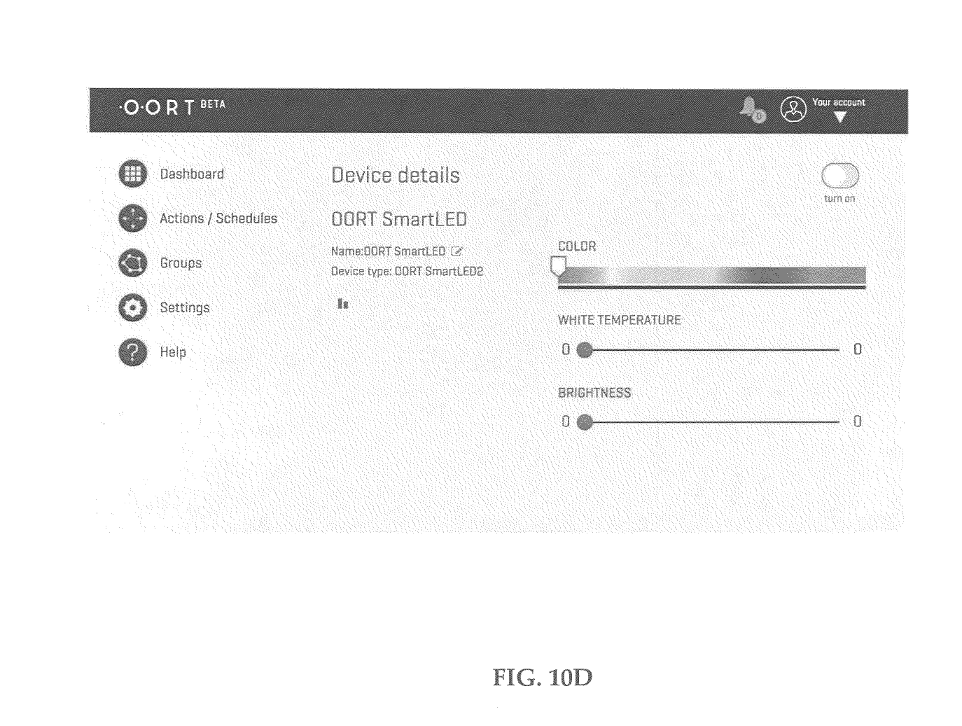

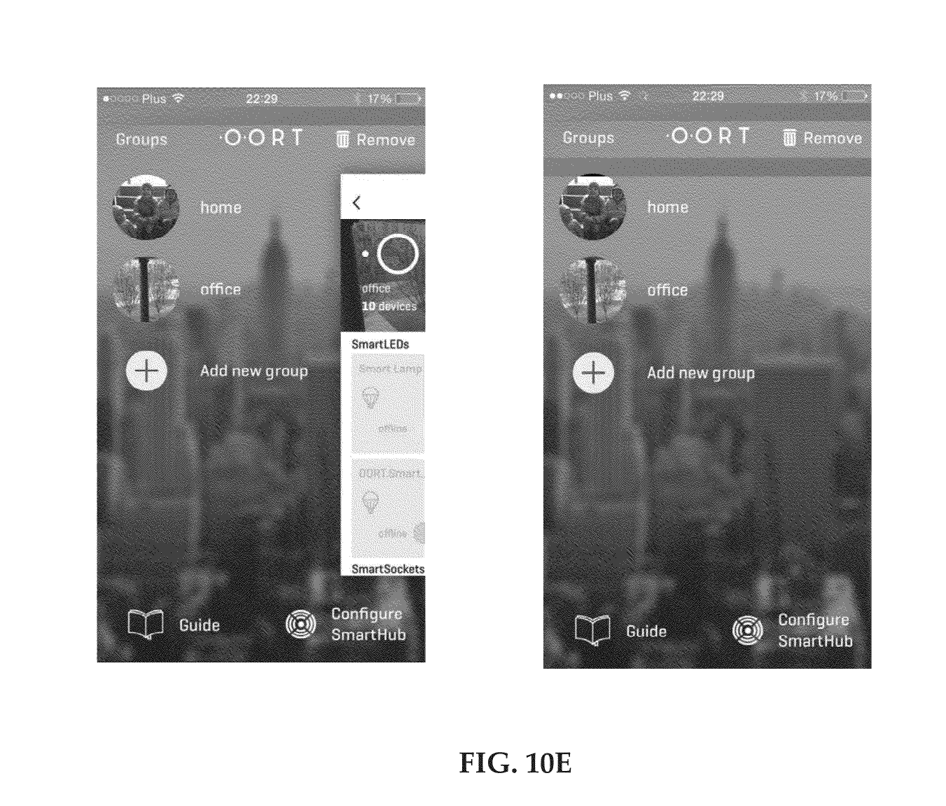

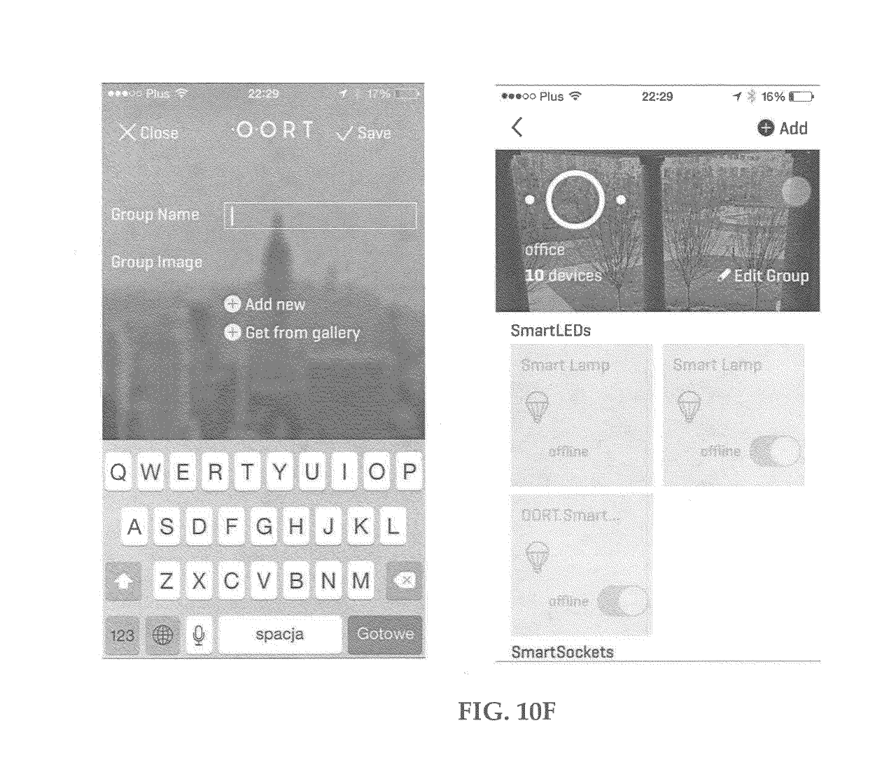

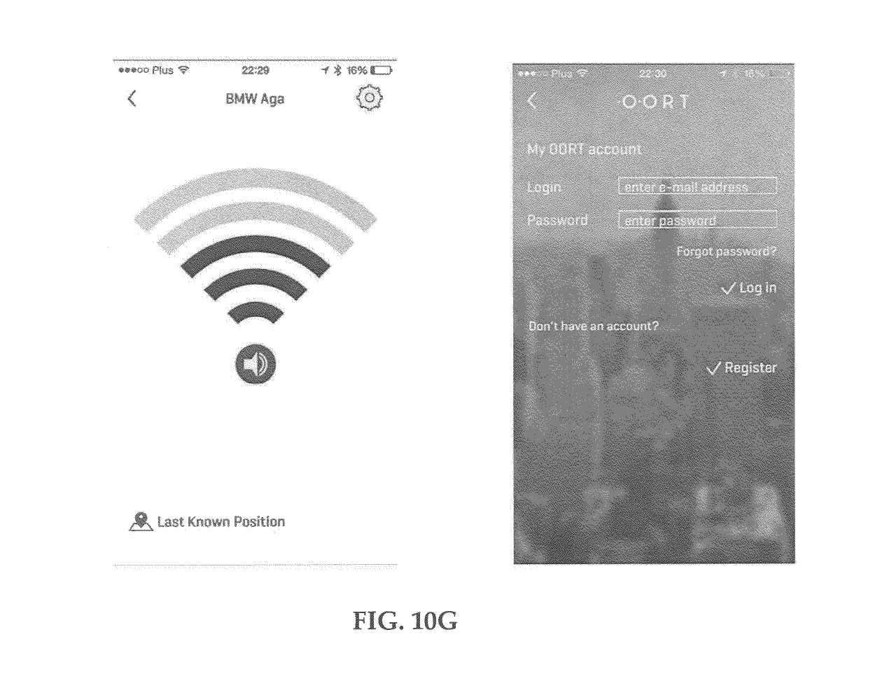

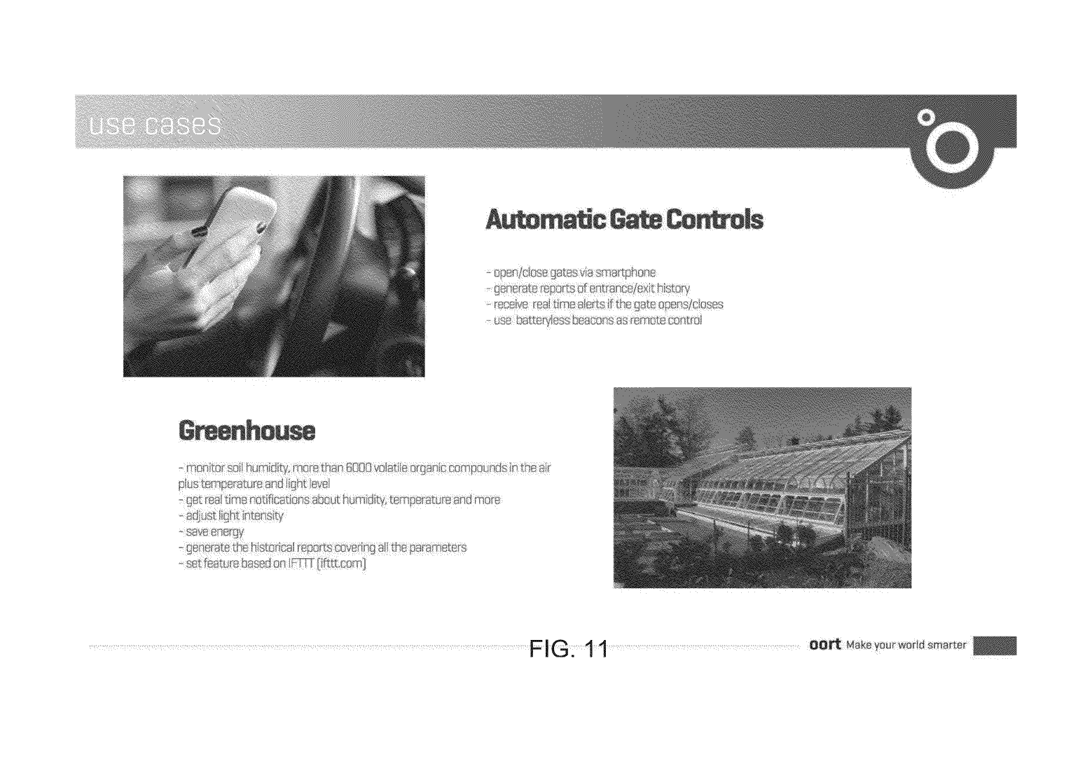

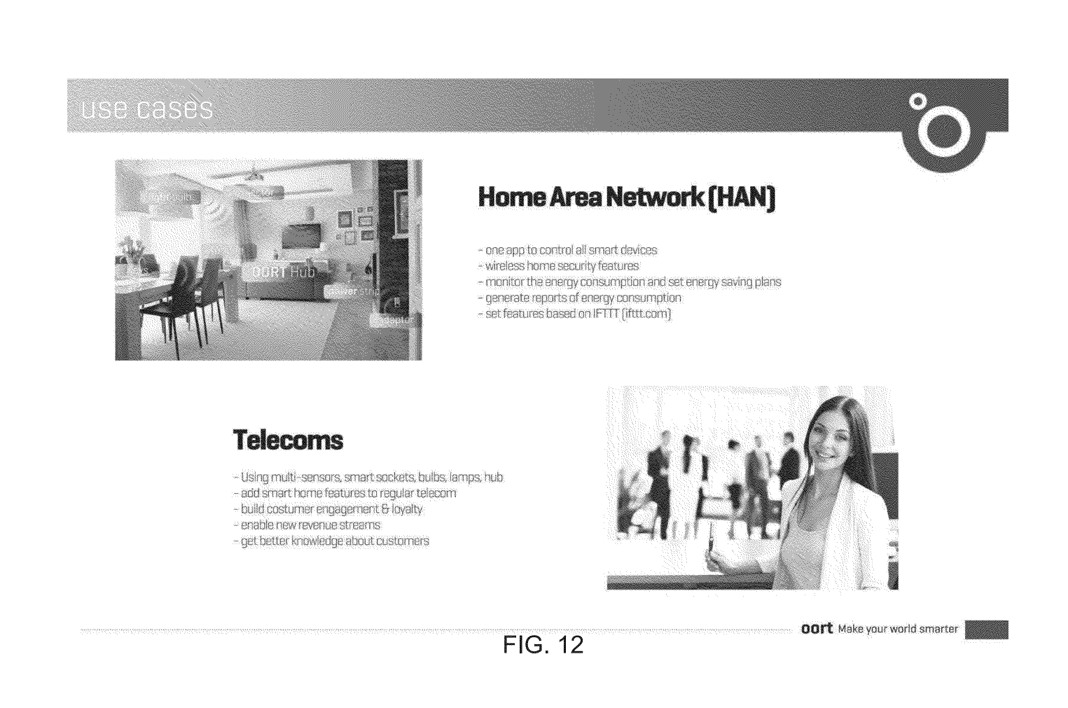

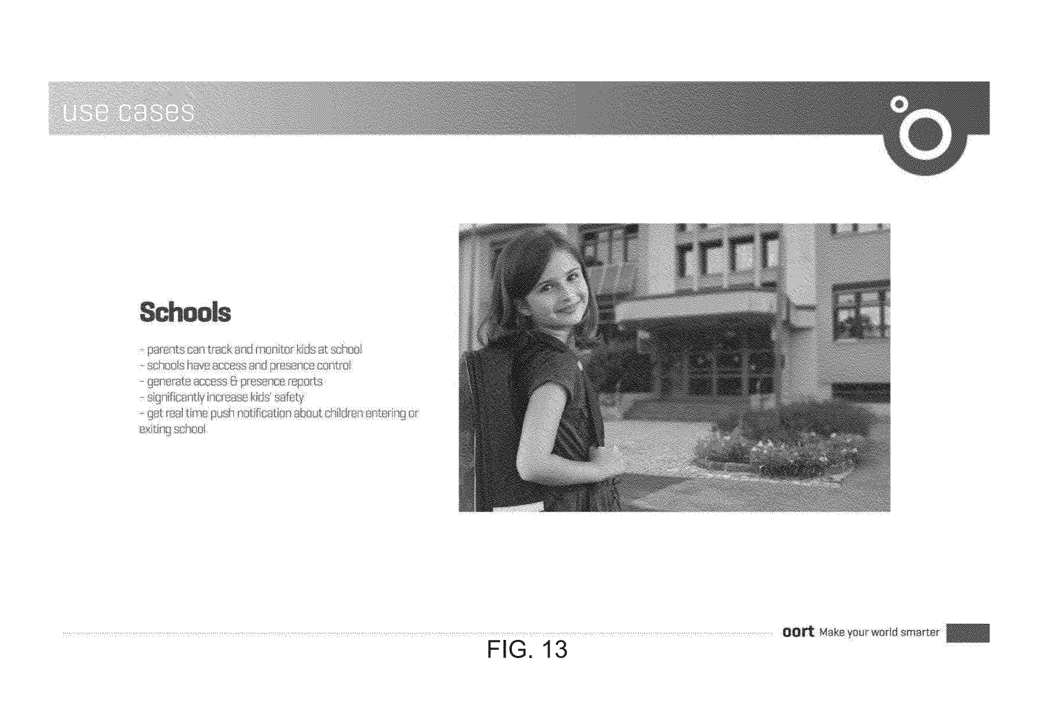

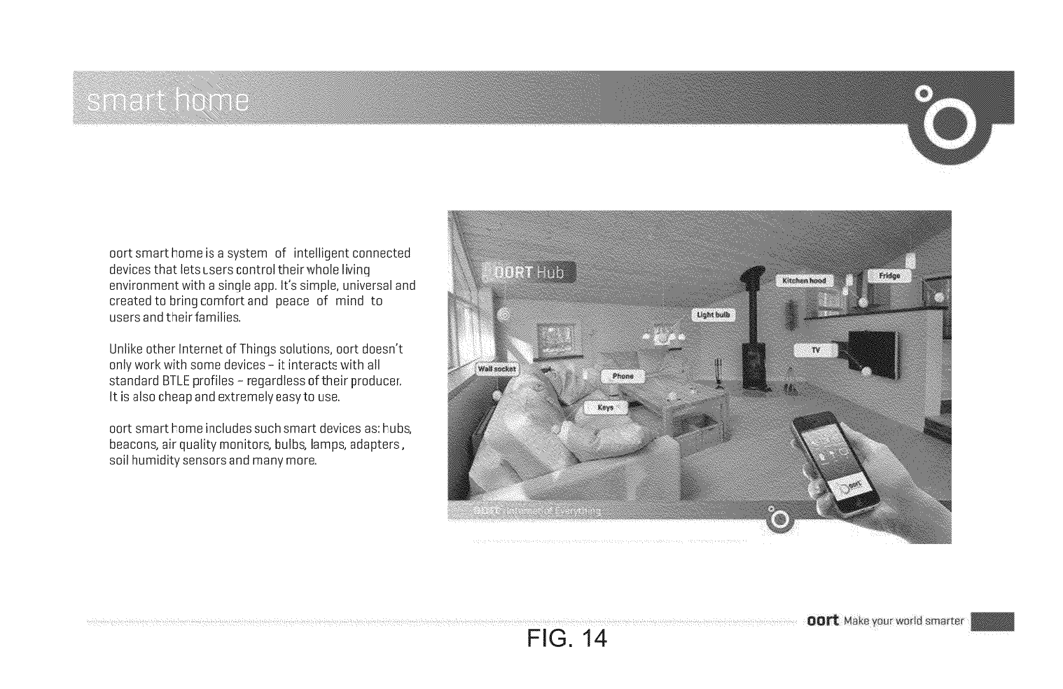

In one embodiment, the hub 510 can communicatively couple with, and is controlled by, an end user computing device (see FIG. 28) that executes an application. Generally, the application provides any needed graphical user interfaces that allow end users to interact with the hub 510 and beacons 505. Example GUIs are illustrated in FIGS. 10A-10G.

The application allows an end user to control each of the beacons 505 individually by providing instructions or control signals to the hub 510. For example, the end user can turn off all the devices in the room. The hub 510 first determines which of the devices in the room are currently on by transmitting a reporting request to the beacons 505 in the room. The beacons 505 respond with a response signal that includes the information requested by the hub 510, which in this case is a power status signal. The hub 510 can determine from these signals which of the device in the room are currently turned on. The hub 510 can cause a list of devices in the room to be displayed. The end user can use the application to request that all devices be turned off. In another example, the end user can turn off devices individually using the application.

As mentioned above, the hub 510 can monitor the operation of each beacon over a given period of time. The hub 510 can store this data in the cloud 515. As mentioned above, the cloud 515 can generate reports that are indicative of statistics for beacons and devices. For example, the cloud 515 can calculate average power consumption for a room for each day in a month. In another example, the cloud 515 can determine peak power periods for a room or a device. The cloud 515 can also determine when devices are consuming power without being used, and calculate how much power such devices are wasting. For example, a gaming console and television may consume power even when the devices are not actively being used. The cloud 515 can generate a report of how much power is being wasted by these devices.

The end user can take action from these types of reports. For example, the end user can specify that a power strip beacon should block the television from drawing power when the television has not be turned on by the end user.

These examples are merely to provide descriptions for how some embodiments of the present technology operate. The types of beacons and devices/objects combinations are diverse and numerous. Thus, the specific operational characteristics of the beacons and devices will control or govern the types of operations that can be controlled with the present technology.

Advantageously, end user can also establish schedules or rules that control how the hub 510 controls or monitors the beacons 505. For example, the end user 505 can setup a rule that requires the hub 510 to turn off all devices that have consumed more than a threshold amount of power over a given period of time. In another example, the end user 505 can setup a rule that requires the hub 510 to turn on all devices as the end user approaches the room. This feature can be accomplished by the hub 510 tracking, for example, the mobile phone used by the end user.

In some embodiments, the hub 510 can track each computing device that comes into communicative contact with the hub 510. For example, the hub 510 can scan all mobile devices that enter a broadcast area of the hub 510. The hub 510 can record any available information that is provided by the mobile device, as well as the location of the mobile device. This data can also be stored on the cloud 515. Every Bluetooth device is equipped with a Bluetooth controller which can act as an ibeacon or alternatively can act as an Eddystone. The present invention makes use of small Bluetooth controllers. For instance, when small Bluetooth controllers are installed in a light bulb, appliance, lamp, or any other physical object, such object can be controlled using a smartphone or tablet thanks to the small Bluetooth controllers. In a dual mode, the Bluetooth controller can work as a controlling chip and the ibeacon simultaneously. The ibeacon is a small radio that advertises every 100 milliseconds, and retailers can install ibeacons in their stores to track and communicate with their customers through the customers' smartphones. Such devices let the system to store and collect information about people's locations and objects' locations indoors. For example, lightbulbs and thermostats having such Bluetooth controllers can work as ibeacons which can track a person's exact location inside their home. The system can build a network of Bluetooth controllers on physical objects which can track a person's location and collect a person's information seamlessly.

In some embodiments, the present technology can be used to facilitate commerce. For example, a hub in a store can be used to broadcast a message to mobile devices that pass nearby. If the mobile device has an application that can communicate with the hub (such as the application described above), the message is displayed to the user on the mobile device. For example, the hub can output a message such as “SALE TODAY, 20% off EVERYTHING!!”. When the mobile device passes in range of the hub, the message is received and displayed by the mobile device. A hub can send communications or messages to a user through the mobile device. At the same time, a hub can track smart phones and other Bluetooth. Ultra Wide Band or Wi-Fi-enabled devices. Using the hubs, the system can gather information such as MAC addresses, device locations, device identifiers, and the like.

According to some embodiments, an end user can access the cloud 515 using the application, when the end user is located too far away from the hub 510 to communicate with the hub 510. In these instances, because the hub 510 is coupled with the cloud 515, the end user can control the hub 510 through the cloud 515. That is, the application that executes on the computing device of the end user can be used to control the hub 510 via the cloud 515. The end user can input commands on their mobile device that are provided by the cloud 515 to the hub 510, allowing the end user to control the hub 510 as if the end user was present near the hub 510.

Advantageously, because the hub 510 can couple with the cloud 515, the end user can access the control and management aspects of the hub 510 remotely. That is, the end user can access web-based interfaces generated by the cloud 515 to control the hub 510. These GUIs are similar to the mobile application GUIs illustrated in FIGS. 10A-10G. In some embodiments, beacons and smart sensors can be directly accessed using a computing device that executes an application of the present technology. That is, while the above examples describe interacting with beacons through the hub, the beacons can also be access directly (not through the hub).

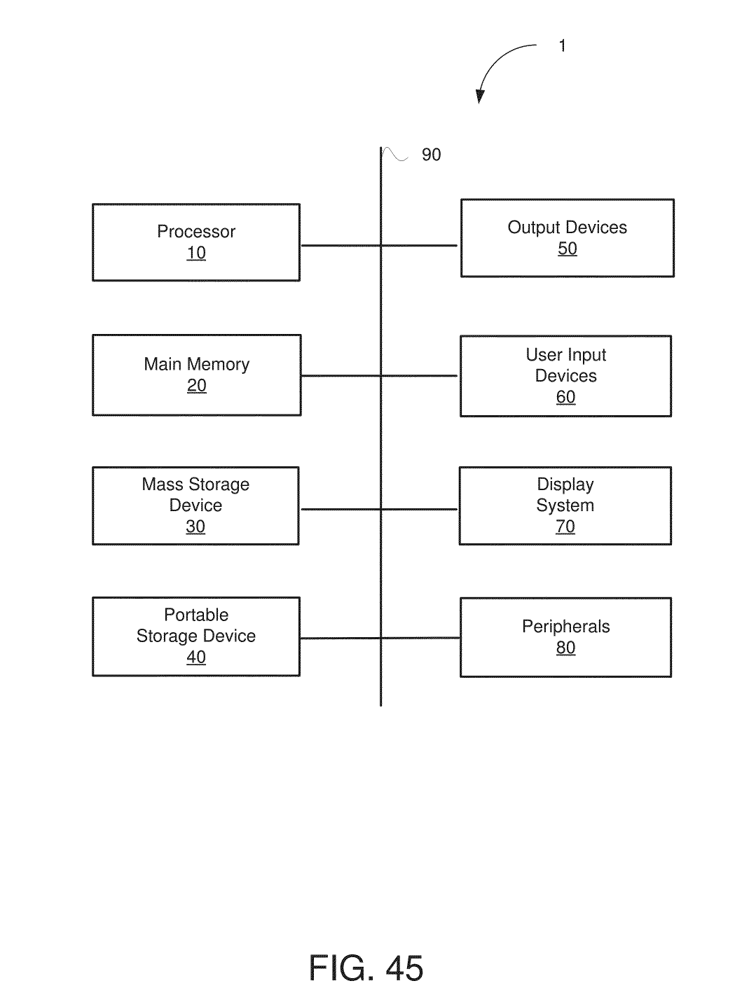

FIG. 45 illustrates an exemplary computing device 1 that may be used to implement an embodiment of the present systems and methods. The system 1 of FIG. 45 may be implemented in the contexts of the likes of the server 130 described herein. The computing device 1 of FIG. 45 includes a processor 10 and main memory 20. Main memory 20 stores, in part, instructions and data for execution by processor 10. Main memory 20 may store the executable code when in operation. The system 1 of FIG. 45 further includes a mass storage device 30, portable storage device 40, output devices 50, user input devices 60, a display system 70, and peripherals 80.

The components shown in FIG. 45 are depicted as being connected via a single bus 90. The components may be connected through one or more data transport means. Processor 10 and main memory 20 may be connected via a local microprocessor bus, and the mass storage device 30, peripherals 80, portable storage device 40, and display system 70 may be connected via one or more input/output (I/O) buses.

Mass storage device 30, which may be implemented with a magnetic disk drive or an optical disk drive, is a non-volatile storage device for storing data and instructions for use by processor 10. Mass storage device 30 can store the system software for implementing embodiments of the present technology for purposes of loading that software into main memory 20.

Portable storage device 40 operates in conjunction with a portable non-volatile storage medium, such as a floppy disk, compact disk or digital video disc, to input and output data and code to and from the computing system 1 of FIG. 45. The system software for implementing embodiments of the present technology may be stored on such a portable medium and input to the computing system 1 via the portable storage device 40.

Input devices 60 provide a portion of a user interface. Input devices 60 may include an alphanumeric keypad, such as a keyboard, for inputting alphanumeric and other information, or a pointing device, such as a mouse, a trackball, stylus, or cursor direction keys. Additionally, the system 1 as shown in FIG. 45 includes output devices 50. Suitable output devices include speakers, printers, network interfaces, and monitors.

Display system 70 may include a liquid crystal display (LCD) or other suitable display device. Display system 70 receives textual and graphical information, and processes the information for output to the display device.

Peripherals 80 may include any type of computer support device to add additional functionality to the computing system. Peripherals 80 may include a modem or a router.

The components contained in the computing system 1 of FIG. 45 are those typically found in computing systems that may be suitable for use with embodiments of the present technology and are intended to represent a broad category of such computer components that are well known in the art. Thus, the computing system 1 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the technology in the form disclosed. Many modifications and variations will be apparent to those of ordinary skill in the art without departing from the scope and spirit of the technology. Exemplary embodiments were chosen and described in order to best explain the principles of the present technology and its practical application, and to enable others of ordinary skill in the art to understand the technology for various embodiments with various modifications as are suited to the particular use contemplated.

Aspects of the present technology are described above with reference to flowchart illustrations and/or block diagrams of methods, apparatus (systems) and computer program products according to embodiments of the technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The cloud system as in FIG. 5 can collect, store, and process data. The system can collect data from any Bluetooth, Wi-Fi, or Ultra Wide Band device in the hub. The system can also collect data from any Bluetooth or Wi-Fi device via a smartphone or tablet. Such data can be shared and monetized with partners. While the present technology has been described in connection with a series of preferred embodiment, these descriptions are not intended to limit the scope of the technology to the particular forms set forth herein. It will be further understood that the methods of the technology are not necessarily limited to the discrete steps or the order of the steps described. To the contrary, the present descriptions are intended to cover such alternatives, modifications, and equivalents as may be included within the spirit and scope of the technology as defined by the appended claims and otherwise appreciated by one of ordinary skill in the art.

What is claimed is:

1. A system, comprising:
a plurality of beacons that each comprise a Bluetooth low energy interface and an interface for communicatively coupling with an electronic device or mechanical device;
a hub that communicates with and controls the plurality of beacons, the hub also comprising a Bluetooth low energy interface and a network interface for coupling with a cloud, the hub collecting data from the plurality of beacons;
the cloud being configured to: process and store the data collected from the plurality of beacons; and generate reports from the data; and
the hub being controlled by an end user computing device when the end user computing device is within a broadcast area of the hub, the end user computing device controlling the hub through the cloud when the end user computing device is not within the broadcast area of the hub.

2. A system, comprising:
a plurality of beacons that each comprise a Wi-Fi interface and an interface for communicatively coupling with an electronic device or mechanical device;
a hub that communicates with and controls the plurality of beacons, the hub also comprising a Wi-Fi low energy interface and a network interface for coupling with a cloud, the hub collecting data from the plurality of beacons;
the cloud being configured to: process and store the data collected from the plurality of beacons; and generate reports from the data; and
the hub being controlled by an end user computing device when the end user computing device is within a broadcast area of the hub, the end user computing device controlling the hub through the cloud when the end user computing device is not within the broadcast area of the hub.

3. A system, comprising:
a plurality of beacons that each comprise a Ultra Wide Band energy interface and an interface for communicatively coupling with an electronic device or mechanical device;
a hub that communicates with and controls the plurality of beacons, the hub also comprising a Ultra Wide Band low energy interface and a network interface for coupling with a cloud, the hub collecting data from the plurality of beacons;
the cloud being configured to: process and store the data collected from the plurality of beacons; and generate reports from the data; and
the hub being controlled by an end user computing device when the end user computing device is within a broadcast area of the hub, the end user computing device controlling the hub through the cloud when the end user computing device is not within the broadcast area of the hub.

4. A system, comprising:
a plurality of beacons that each comprise a GSM network interface and an interface for communicatively coupling with an electronic device or mechanical device;
a hub that communicates with and controls the plurality of beacons, the hub also comprising a GSM network interface and a network interface for coupling with a cloud, the hub collecting data from the plurality of beacons;
the cloud being configured to: process and store the data collected from the plurality of beacons; and generate reports from the data; and
the hub being controlled by an end user computing device when the end user computing device is within a broadcast area of the hub, the end user computing device controlling the hub through the cloud when the end user computing device is not within the broadcast area of the hub.

5. A system, comprising:
a plurality of beacons that each comprise a dual band Ultra Wide Band and Bluetooth interface and an interface for communicatively coupling with an electronic device or mechanical device;
a hub that communicates with and controls the plurality of beacons, the hub also comprising a dual band network interface and a network interface for coupling with a cloud, the hub collecting data from the plurality of beacons;
the cloud being configured to: process and store the data collected from the plurality of beacons; and generate reports from the data; and
the hub being controlled by an end user computing device when the end user computing device is within a broadcast area of the hub, the end user computing device controlling the hub through the cloud when the end user computing device is not within the broadcast area of the hub.
